(19) United States
(12) Patent Application Publication
(10) Pub. No.: US 2026/0086429 A1
(43) Pub. Date: Mar. 26, 2026

(54) IMAGING LENS DRIVING MODULE, CAMERA MODULE AND ELECTRONIC DEVICE

(71) Applicant: LARGAN PRECISION CO., LTD., Taichung City (TW)

(72) Inventors: Heng-Yi SU, Taichung City (TW); Yi Hua TSENG, Taichung City (TW); Te-Sheng TSENG, Taichung City (TW)

(21) Appl. No.: 19/333,463

(22) Filed: Sep. 19, 2025

Related U.S. Application Data
(60) Provisional application No. 63/698,637, filed on Sep. 25, 2024.

(51) Int. Cl. G03B 9/06

(52) U.S. Cl. CPC G03B 9/06

(57) ABSTRACT

An imaging lens driving module includes a lens carrier, an imaging lens assembly, a first frame element, a variable aperture element, a circuit board, a flexible wire plate, a first driving element and a second driving element. The imaging lens assembly is disposed in the lens carrier. The imaging lens assembly is disposed on a first rail of the first frame element via a first ball element. The variable aperture element is disposed on the lens carrier. The circuit board is disposed on an image side of the imaging lens assembly. The flexible wire plate is coupled to the circuit board and the lens carrier. The first driving element is for rotating blades of the variable aperture element for enlarging or shrinking an aperture hole. The second driving element is for driving the lens carrier to move along a first direction.

### RELATED APPLICATIONS

This application claims priority to Provisional Application Ser. No. 63/698,637, filed Sep. 25, 2024, which is herein incorporated by reference.

### BACKGROUND

### Technical Field

The present disclosure relates to an imaging lens driving module and a camera module. More particularly, the present disclosure relates to an imaging lens driving module and a camera module applicable to portable electronic devices.

### Description of Related Art

In recent years, portable electronic devices have developed rapidly. For example, intelligent electronic devices and tablets have been filled in the lives of modern people, and camera modules mounted on portable electronic devices have also prospered. However, as technology advances, the quality requirements of the camera module are becoming higher and higher.

Therefore, a camera module, which can enhance the image quality, needs to be developed.

### SUMMARY

According to one aspect of the present disclosure, an imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is rotatable relative to the fixing portion, and has at least two blades. The aperture hole is formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion, a second flexible portion and a restrained element. The fixing end is coupled and fixed to the circuit board. The movable end is coupled and fixed to the lens carrier. The first flexible portion is connected to the movable end. The second flexible portion is connected to the first flexible portion and the fixing end, wherein the second flexible portion is closer to the fixing end than the first flexible portion to the fixing end. The restrained element is coupled with the first flexible portion and the second flexible portion so as to form an angle between the first flexible portion and the second flexible portion. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches and a node. The meandering branches extend away from the fixing end, wherein the at least two meandering branches are overlapped observed along a specific direction. The meandering branches are converged at the node on a way extending towards the fixing end. When a shortest length of the second flexible portion along a direction parallel to the optical axis is D, and a total length of the meandering branches is L, the following conditions are satisfied: D<L; and 1.4<L/D<17.

According to one aspect of the present disclosure, an imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is rotatable relative to the fixing portion, and has at least two blades. The aperture hole is formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion and a second flexible portion. The fixing end is coupled and fixed to the circuit board. The movable end is coupled and fixed to the lens carrier. The first flexible portion is connected to the movable end. The second flexible portion is connected to the first flexible portion and the fixing end, wherein the second flexible portion is closer to the fixing end than the first flexible portion to the fixing end. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches extending away from the fixing end, the meandering branches are overlapped observed along a specific direction. The second flexible portion has a maximum width being Wc close to the first flexible portion, and each of the meandering branches has a minimum width Wf close to the fixing end, the following conditions are satisfied: Wf<Wc; and 1.5<Wc/Wf<16.

According to one aspect of the present disclosure, an imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is rotatable relative to the fixing portion, and has at least two blades. The aperture hole is formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion, a second flexible portion and a turning section. The fixing end is coupled and fixed to the circuit board. The movable end is coupled and fixed to the lens carrier. The first flexible portion is connected to the movable end. The second flexible portion is connected to the fixing end, wherein the second flexible portion is closer to the fixing end than the first flexible portion to the fixing end. One end of the turning section is connected to the first flexible portion, the other end of the turning section is connected to the second flexible portion, and an angle is formed between the first flexible portion and the second flexible portion. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches and a node. The meandering branches extend away from the fixing end, wherein the meandering branches are overlapped observed along a specific direction. The meandering branches are converged at the node on a way extending towards the fixing end. When a shortest distance between the fixing end and the node along the optical axis is Hn, and a shortest length of the second flexible portion along the optical axis is D, the following conditions are satisfied: Hn<D; and 0.1≤Hn/D≤0.5.

According to one aspect of the present disclosure, a camera module includes the imaging lens driving module of the aforementioned aspect and an image sensor, wherein the image sensor is relative to an image surface of the imaging lens assembly in the imaging lens driving module.

According to one aspect of the present disclosure, an electronic device includes the camera module of the aforementioned aspect.

### BRIEF DESCRIPTION OF THE DRAWINGS

FIG. 1A is a schematic view of a camera module according to one example of the 1st embodiment of the present disclosure.

FIG. 1B is a plan view of the camera module of FIG. 1A.

FIG. 1C is a cross-sectional view along line 1C-1C of FIG. 1B.

FIG. 1D is an exploded view of the camera module of FIG. 1A.

FIG. 1E is another exploded view of the camera module of FIG. 1A.

FIG. 1F is a three dimensional view of a lens carrier, a variable aperture element and a flexible wire plate of the camera module of FIG. 1E.

FIG. 1G is an exploded view of partial elements of the camera module of FIG. 1F.

FIG. 1H is another exploded view of the camera module of FIG. 1A.

FIG. 1I is a plan view of the flexible wire plate of the camera module of FIG. 1G.

FIG. 1J is a schematic view of partial parameters of the camera module of FIG. 1A.

FIG. 1K is another plan view of the flexible wire plate of FIG. 1G.

FIG. 1L is a three dimensional view of a flexible wire plate of a camera module according to another example of the 1st embodiment of the present disclosure.

FIG. 1M is a plan view of the flexible wire plate of FIG. 1L.

FIG. 1N is another plan view of the flexible wire plate of FIG. 1L.

FIG. 1O is another plan view of the flexible wire plate of FIG. 1L.

FIG. 2A is a plan view of a flexible wire plate of a camera module according to one example of the 2nd embodiment of the present disclosure.

FIG. 2B is a three dimensional view of the flexible wire plate and a first driving element of the camera module of FIG. 2A.

FIG. 2C is a plan view of the first driving element of FIG. 2B.

FIG. 2D is another plan view of the flexible wire plate of FIG. 2A.

FIG. 2E is a cress-sectional view along line 2E-2E of FIG. 2D.

FIG. 3A is an exploded view of a variable aperture element and a flexible wire plate of a camera module according to one example of the 3rd embodiment of the present disclosure.

FIG. 3B is a plan view of the flexible wire plate of FIG. 3A.

FIG. 4A is an exploded view of a variable aperture element and a flexible wire plate of a camera module according to one example of the 4th embodiment of the present disclosure.

FIG. 4B is a plan view of the flexible wire plate of FIG. 4A.

FIG. 5A is a schematic view of an electronic device according to the 5th embodiment of the present disclosure.

FIG. 5B is another schematic view of the electronic device according to the 5th embodiment of FIG. 5A.

FIG. 5C is a schematic view of an image captured via the electronic device according to the 5th embodiment of FIG. 5A.

FIG. 5D is another schematic view of the image captured via the electronic device according to the 5th embodiment of FIG. 5A.

FIG. 5E is the other schematic view of the image captured via the electronic device according to the 5th embodiment of FIG. 5A.

FIG. 6 is a schematic view of an electronic device according to the 6th embodiment of the present disclosure.

FIG. 7A is a schematic view of a vehicle instrument according to the 7th embodiment of the present disclosure.

FIG. 7B is another schematic view of the vehicle instrument according to the 7th embodiment in FIG. 7A.

FIG. 7C is another schematic view of the vehicle instrument according to the 7th embodiment in FIG. 7A.

### DETAILED DESCRIPTION

An imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is movable relative to the fixing portion, and has at least two blades. The aperture hole is formed by the at least two blades, wherein at least two second ball elements are disposed between the fixing portion and the rotating portion, the fixing portion and the rotating portion are movable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion, a second flexible portion and a restrained element. The fixing end is coupled to the circuit board. The movable end is coupled to the lens carrier. The first flexible portion is connected to the movable end. The second flexible portion is connected to the first flexible portion and the fixing end, wherein the second flexible portion is closer to the fixing end than the first flexible portion to the fixing end. The restrained element is coupled with the first flexible portion and the second flexible portion so as to form an angle between the first flexible portion and the second flexible portion. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches and a node. The meandering branches extend away from the fixing end, wherein the at least two meandering branches are overlapped observed along a specific direction. The meandering branches are converged at the node on a way extending towards the fixing end. When a shortest length of the second flexible portion along a direction parallel to the optical axis is D, and a total length of the meandering branches is L, the following conditions are satisfied: D<L; and 1.4<L/D<17. Therefore, when the first frame element is moved and pulls the flexible wire plate, the force generated during pulling the flexible wire plate can be dispersed via the angle between the first flexible portion and the second flexible portion, so that the flexible wire plate can be prevented from damage. Further, when the aforementioned condition is satisfied, the flexible wire plate can provide expansion margin by the arrangement of the meandering branches, so that the pulling force to the flexible wire plate generated during the movement of the first frame element can be reduced so as to increase the service life of the flexible wire plate. It is favorable for enhancing the structure strength of the second flexible portion by converging the meandering branches via the node. It is favorable for preventing the force focusing on the bending part between the first flexible portion and the second flexible portion during the movement of the first frame element via the restrained element to fix the angle between the first flexible portion and the second flexible portion.

Specifically, the movable end of the flexible wire plate is fixed on the lens carrier so as to drive the variable aperture element to move simultaneously. The first ball is disposed between the first rail and the lens carrier, so that the auto-focusing effect can be achieved during the lens carrier is moved with the flexible wire plate along the first rail. The present disclosure provides the auto-focusing effect. The variable aperture element provides the aperture hole which can be enlarged or shrunk via the second ball elements with ball structure to drive the rotating portion to rotate. The restrained element can be hard material, soft material or form on the flexible wire plate integrally to form a thicker portion, and will not be limited thereto. The node can be a section of the flexible wire plate, or can be other structure for converging and connecting the meandering branches, and will not be limited thereto. The meandering branches are overlapped observed along a specific direction, so that it is favorable for narrowing the second flexible portion under the specific expansion margin. In the present disclosure, the total length of the meandering branches represents the total length of the two meandering branches, and the shortest distance between the fixing end and the node should be a straight-line distance from the restrained element to the fixing end. There is no limitation of the angel between the first flexible portion and the second flexible portion.

The first frame element has a second surface relative to the first surface. The imaging lens driving module further includes a second frame element and a third frame element. The second frame element has a third surface and a fourth surface, which are relative to each other, wherein the third surface is movably disposed relative to the second surface, thus the second frame element is movable along a second direction, the second direction is perpendicular to the first direction. The third frame element has a fifth surface, which is movably disposed relative to the fourth surface, thus the third frame element is movable along a third direction, wherein the third direction is perpendicular to the first direction and the second direction. Therefore, the pulling margin of the flexible wire plate is enough for the deformation generated by Optical Image Stabilization (OIS) and the auto-focusing. Further, the second frame element can further provide movements of two directions so as to add OIS functions.

The second surface has a second rail extending along the second direction, the third surface has a third rail relative to the second rail, the third rail extends along the second direction, the fourth surface has a fourth rail extending along the third direction, the fifth surface has a fifth rail extending along the third direction. The imaging lens driving module further includes a third ball element and a fourth ball element. The third ball element is disposed between the second rail and the third rail, thus the first frame element and the second frame element are movable relative to each other along the second direction. The fourth ball element is disposed between the fourth rail and the fifth rail, thus the second frame element and the third frame element are movable relative to each other along the third direction. The circuit board includes a third coil and at least two fourth coils, the third coil is disposed relative to a second magnet of the first frame element, and the at least two fourth coils are disposed relative to at least two third magnets of the first frame element, respectively. Therefore, all of the third coil and the fourth coils are disposed on the circuit board, which is favorable for simplifying the arrangement of the coils so as to reduce the thickness along the optical axis of the imaging lens driving module.

The third magnets are disposed on the second surface, the fourth coils are disposed on the circuit board, the second frame element has at least two openings relative to the fourth coils, the fourth coils are disposed relative to at least two third magnets, respectively. By disposing the fourth coils on the circuit board facing towards the second frame element, and disposing the fourth coils directly facing the magnets through the opening, it is favorable for increasing the electromagnetic effect. Further, it is also favorable for achieving the movement of the second frame element by reducing the thicknesses of the fourth coils and the magnets to generate sufficient pushing force.

The third coil is disposed on the circuit board and relative to the second magnet. It is favorable for reducing the entire thickness to make the imaging lens driving module being flatter by arranging three coils on the same surface.

The first driving element can include a first coil and a first magnet. The first coil is disposed on the fixing portion. The first magnet is disposed on the rotating portion, wherein the first coil is relative to the first magnet, the rotating portion can be driven to move relatively to the fixing portion by the first coil and the first magnet, thus the at least two blades are driven for enlarging or shrinking the aperture hole. Therefore, it is favorable for reducing the volume proportion of the flexible wire plate in the imaging lens driving module by arranging the denser paperclip structure so as to increase the utilization efficiency of the inner space of the camera module.

The second driving element can include a second magnet and a second coil. The second magnet is fixed on the first frame element. The second coil is fixed on the movable end, wherein the second magnet is relative to the second coil, the lens carrier is driven by the second magnet and the second coil to move along the first direction. It is favorable for molding by arranging the looser crab-shaped structure, and also favorable for cutting the flexible wire plate during the molding and manufacturing so as to increase the yield rate.

The second flexible portion has a maximum width being Wc close to the first flexible portion, and each of the meandering branches has a minimum width Wf close to the fixing end, the following conditions are satisfied: Wf<Wc; and 1.5<Wc/Wf<16. Therefore, it is favorable for increasing the force distribution effect by the arrangement of the crab-shaped structure which is wide at the top and narrow at the bottom.

The second flexible portion can further include a side vertical portion connected to at least one of the meandering branches. Therefore, it is favorable for enhancing the structural strength of the second flexible portion via the side vertical portion.

The flexible wire plate includes polyimide. The flexible wire plate can obtain better elastic restoring force with the material.

An imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is movable relative to the fixing portion, and has at least two blades. The aperture hole is formed by the at least two blades, wherein at least two second ball elements are disposed between the fixing portion and the rotating portion, the fixing portion and the rotating portion are movable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion and a second flexible portion. The fixing end is coupled to the circuit board. The movable end is coupled to the lens carrier. The first flexible portion is connected to the movable end. The second flexible portion is connected to the first flexible portion and the fixing end, wherein the second flexible portion is closer to the fixing end than the first flexible portion to the fixing end. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches extending away from the fixing end, the meandering branches are overlapped observed along a specific direction. The second flexible portion has a maximum width being Wc close to the first flexible portion, and each of the meandering branches has a minimum width Wf close to the fixing end, the following conditions are satisfied: Wf<Wc; and 1.5<Wc/Wf<16. When the aforementioned conditions are satisfied, the force can be dispersed when the second flexible portion is pulled so as to increase the service life of the flexible wire plate.

Specifically, the movable end of the flexible wire plate is fixed on the lens carrier so as to drive the variable aperture element to move simultaneously. The first ball is disposed between the first rail and the lens carrier, so that the auto-focusing effect can be achieved during the lens carrier is moved with the flexible wire plate along the first rail. The present disclosure provides the auto-focusing effect. The variable aperture element provides the aperture hole which can be enlarged or shrunk via the second ball elements with ball structure to drive the rotating portion to rotate. The variable aperture element of the present disclosure is rolling-ball-type structure. The meandering branches are overlapped observed along a specific direction, so that it is favorable for narrowing the second flexible portion under the specific expansion margin. The second flexible portion defines a wider part (that is, the maximum width Wc) and a narrower part (that is, the minimum width Wf), so that the force of the second flexible portion can be dispersed. The maximum width Wc and the minimum width Wf of the second flexible portion are defined along the direction parallel to the third direction of the surface of the first direction and the third direction where the two meandering branches thereon.

The first frame element has a second surface relative to the first surface. The imaging lens driving module further includes a second frame element and a third frame element. The second frame element has a third surface and a fourth surface, which are relative to each other, wherein the third surface is movably disposed relative to the second surface, thus the second frame element is movable along a second direction, the second direction is perpendicular to the first direction. The third frame element has a fifth surface, which is movably disposed relative to the fourth surface, thus the third frame element is movable along a third direction, wherein the third direction is perpendicular to the first direction and the second direction. Therefore, the pulling margin of the flexible wire plate is enough for the deformation generated by OIS and the auto-focusing. Further, the second frame element can further provide movements of two directions so as to add OIS functions.

The second surface has a second rail extending along the second direction, the third surface has a third rail relative to the second rail, the third rail extends along the second direction, the fourth surface has a fourth rail extending along the third direction, the fifth surface has a fifth rail extending along the third direction. The imaging lens driving module further includes a third ball element and a fourth ball element. The third ball element is disposed between the second rail and the third rail, thus the first frame element and the second frame element are movable relative to each other along the second direction. The fourth ball element is disposed between the fourth rail and the fifth rail, thus the second frame element and the third frame element are movable relative to each other along the third direction. The circuit board includes a third coil and at least two fourth coils, the third coil is disposed relative to a second magnet of the first frame element, and the at least two fourth coils are disposed relative to at least two third magnets of the first frame element, respectively. Therefore, all of the third coil and the fourth coils are disposed on the circuit board, which is favorable for simplifying the assembling of the coils so as to reduce time for assembling.

The third magnets are disposed on the second surface, the fourth coils are disposed on the circuit board, the second frame element has at least two openings relative to the fourth coils, the fourth coils are disposed relative to at least two third magnets, respectively. By disposing the fourth coils on the circuit board facing towards the second frame element, and disposing the fourth coils directly facing the magnets through the opening, it is favorable for increasing the electromagnetic effect. Further, it is also favorable for achieving the movement of the second frame element by reducing the thicknesses of the fourth coils and the magnets to generate sufficient pushing force.

The third coil is disposed on the circuit board and relative to the second magnet. It is favorable for reducing the entire thickness to make the imaging lens driving module being flatter by arranging three coils on the same surface.

The first driving element can include a first coil and a first magnet. The first coil is disposed on the fixing portion. The first magnet is disposed on the rotating portion, wherein the first coil is relative to the first magnet, the rotating portion can be driven to move relatively to the fixing portion by the first coil and the first magnet, thus the at least two blades are driven for enlarging or shrinking the aperture hole. Therefore, it is favorable for reducing the volume proportion of the flexible wire plate in the imaging lens driving module by arranging the denser paperclip structure so as to increase the utilization efficiency of the inner space of the camera module.

The second driving element can include a second magnet and a second coil. The second magnet is fixed on the first frame element. The second coil is fixed on the movable end, wherein the second magnet is relative to the second coil, the lens carrier is driven by the second magnet and the second coil to move along the first direction. It is favorable for molding by arranging the looser crab-shaped structure, and also favorable for cutting the flexible wire plate during the molding and manufacturing so as to increase the yield rate.

The second flexible portion has the maximum width being Wc close to the first flexible portion, and each of the meandering branches has the minimum width Wf close to the fixing end, the following conditions are satisfied: Wf<Wc; and 1.9<Wc/Wf<12.7. Therefore, it is favorable for increasing the force distribution effect by the arrangement of the crab-shaped structure which is wide at the top and narrow at the bottom.

The second flexible portion can further include a side vertical portion connected to at least one of the meandering branches. Therefore, it is favorable for enhancing the structural strength of the second flexible portion via the side vertical portion.

The flexible wire plate can further include a restrained element coupled with the first flexible portion and the second flexible portion so as to form an angle between the first flexible portion and the second flexible portion. The force can be distributed evenly on the first flexible portion and the second flexible portion by fixing the angle therebetween via the restrained element. Further, it is favorable for preventing the force focusing on the bending part between the first flexible portion and the second flexible portion during the movement of the first frame element via the restrained element to fix the angle between the first flexible portion and the second flexible portion, so that the service life of the flexible wire plate can be increased.

The flexible wire plate includes polyimide. The flexible wire plate can obtain better elastic restoring force with the material.

An imaging lens driving module includes a lens carrier, an imaging lens assembly, a first frame element, a variable aperture element, a circuit board, a flexible wire plate, a first driving element and a second driving element. The imaging lens assembly has an optical axis, and is disposed in the lens carrier. The first frame element has a first surface, wherein a first rail is disposed on the first surface along a first direction, the first direction is parallel to the optical axis, the imaging lens assembly is disposed on the first rail via a first ball element. The variable aperture element includes a fixing portion, a rotating portion and an aperture hole. The fixing portion is fixed on the lens carrier. The rotating portion is rotatable relative to the fixing portion, and has at least two blades. The aperture hole is formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole. The circuit board is disposed on an image side of the imaging lens assembly. The flexible wire plate includes a fixing end, a movable end, a first flexible portion, a second flexible portion and a turning section. The fixing end is coupled to the circuit board. The movable end is coupled to the lens carrier. The first flexible portion is connected to the movable end. The second flexible portion is connected to the first flexible portion and the fixing end, wherein the second flexible portion is closer to the fixing end than the first flexible portion to the fixing end. One end of the turning section is connected to the first flexible portion, the other end of the turning section is connected to the second flexible portion, and an angle is formed between the first flexible portion and the second flexible portion. The first driving element is for driving the rotating portion to rotate relative to the fixing portion so as to rotate the at least two blades for enlarging or shrinking the aperture hole. The second driving element is for driving the lens carrier to move along the first direction. The first driving element and the second driving element are both electrically connected to the flexible wire plate. The second flexible portion of the flexible wire plate includes at least two meandering branches and a node. The meandering branches extend away from the fixing end, wherein the meandering branches are overlapped observed along a specific direction. The meandering branches are converged at the node on a way extending towards the fixing end. When a shortest distance between the fixing end and the node along the optical axis is Hn, and a shortest length of the second flexible portion along the optical axis is D, the following conditions are satisfied: Hn<D; and 0.1≤Hn/D≤0.5. To define the turning section by the meandering branches, the first flexible portion and the second flexible portion can be located on the different planes, and the force can be dispersed on different planes. Further, to define the location of the node near the fixing end by the distance, it is favorable for converging the meandering branches so as to enhance the structural strength of the second flexible portion.

Specifically, the turning section is the turning position of the meandering branches on the surface of the first direction and the third direction, wherein there is no limitation of the turning angel. Therefore, the total length of the second flexible portion can be extended. The flexible portion width of the second flexible portion is defined along the third direction by the meandering branches on the surface of the first direction and the third direction.

Further, the following condition can be satisfied: 0.2≤Hn/D≤0.5.

The first frame element has a second surface relative to the first surface. The imaging lens driving module further includes a second frame element and a third frame element. The second frame element has a third surface and a fourth surface, which are relative to each other, wherein the third surface is movably disposed relative to the second surface, thus the second frame element is movable along a second direction, the second direction is perpendicular to the first direction. The third frame element has a fifth surface, which is movably disposed relative to the fourth surface, thus the third frame element is movable along a third direction, wherein the third direction is perpendicular to the first direction and the second direction. Therefore, the pulling margin of the flexible wire plate is enough for the deformation generated by OIS and the auto-focusing. Further, the second frame element can further provide movements of two directions so as to add OIS functions.

The second surface has a second rail extending along the second direction, the third surface has a third rail relative to the second rail, the third rail extends along the second direction, the fourth surface has a fourth rail extending along the third direction, the fifth surface has a fifth rail extending along the third direction. The imaging lens driving module further includes a third ball element and a fourth ball element. The third ball element is disposed between the second rail and the third rail, thus the first frame element and the second frame element are movable relative to each other along the second direction. The fourth ball element is disposed between the fourth rail and the fifth rail, thus the second frame element and the third frame element are movable relative to each other along the third direction. The circuit board includes a third coil and at least two fourth coils, the third coil is disposed relative to a second magnet of the first frame element, and the at least two fourth coils are disposed relative to at least two third magnets of the first frame element, respectively. Therefore, all of the third coil and the fourth coils are disposed on the circuit board, which is favorable for simplifying the assembling of the coils so as to reduce time for assembling. The third magnets are disposed on the second surface, the fourth coils are disposed on the circuit board, the second frame element has at least two openings relative to the fourth coils, the fourth coils are disposed relative to at least two third magnets, respectively. By disposing the fourth coils on the circuit board facing towards the second frame element, and disposing the fourth coils directly facing the third magnets through the opening, it is favorable for increasing the electromagnetic effect. Further, it is also favorable for achieving the movement of the second frame element by reducing the thicknesses of the fourth coils and the magnets to generate sufficient pushing force. The fourth coil can be further disposed on the circuit board via the third frame element, so that the elements can be modularized so as to achieve the effect for simplifying the assembling steps.

The third coil is disposed on the circuit board and relative to the second magnet. It is favorable for reducing the entire thickness to make the imaging lens driving module being flatter by arranging three coils on the same surface.

The first driving element can include a first coil and a first magnet. The first coil is disposed on the fixing portion. The first magnet is disposed on the rotating portion, wherein the first coil is relative to the first magnet, the rotating portion can be driven to move relatively to the fixing portion by the first coil and the first magnet, thus the at least two blades are driven for enlarging or shrinking the aperture hole. Therefore, it is favorable for adjusting the size of aperture.

The second driving element can include a second magnet and a second coil. The second magnet is fixed on the first frame element. The second coil is fixed on the movable end, wherein the second magnet is relative to the second coil, the lens carrier is driven by the second magnet and the second coil to move along the first direction. Therefore, it is favorable for achieving the zooming effect.

The second flexible portion has a maximum width being Wc close to the first flexible portion, and each of the meandering branches has a minimum width Wf close to the fixing end, the following conditions are satisfied: Wf<Wc; and 1.5<Wc/Wf<16. Therefore, it is favorable for increasing the force distribution effect by the arrangement of the crab-shaped structure which is wide at the top and narrow at the bottom.

The second flexible portion can further include a side vertical portion connected to at least one of the meandering branches. Therefore, it is favorable for enhancing the structural strength of the second flexible portion via the side vertical portion.

The flexible wire plate includes polyimide. The flexible wire plate can obtain better elastic restoring force with the material.

The first flexible portion extends along a direction perpendicular to the optical axis, the second flexible portion extends the direction parallel to the optical axis. Therefore, it is favorable for dispersing the force on different locations of the entire flexible wire plate by arranging the first flexible portion and the second flexible portion on different planes, so that the force on the single point can be reduced.

A camera module includes the imaging lens driving module of the aforementioned aspect and an image sensor, wherein the image sensor is relative to an image surface of the imaging lens assembly in the imaging lens driving module.

An electronic device includes the camera module of the aforementioned aspect.

### 1st Embodiment

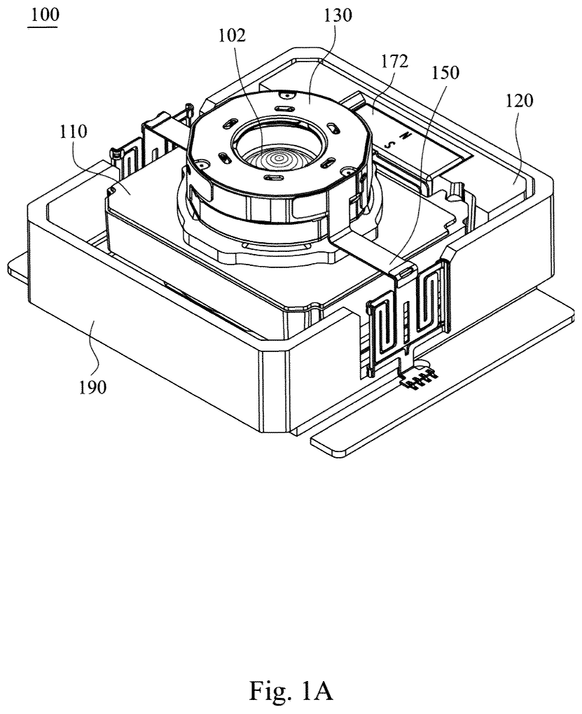

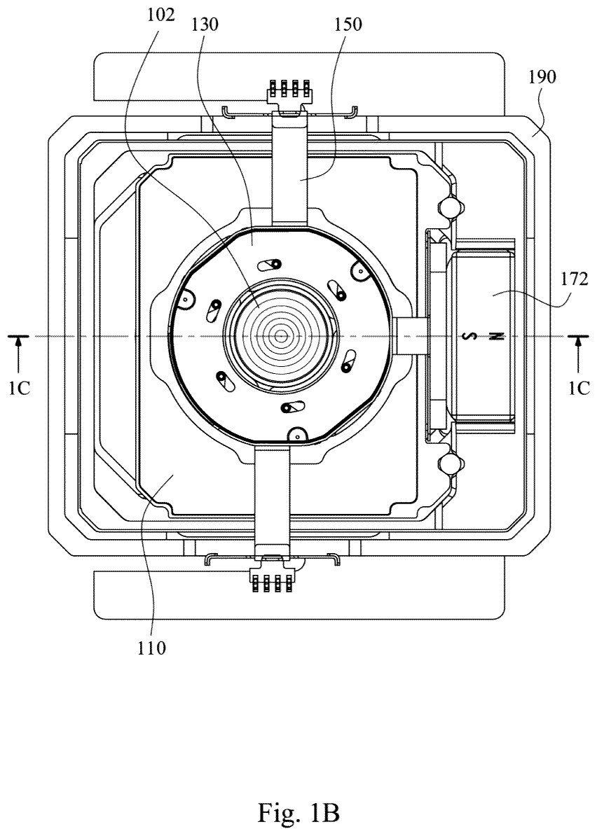

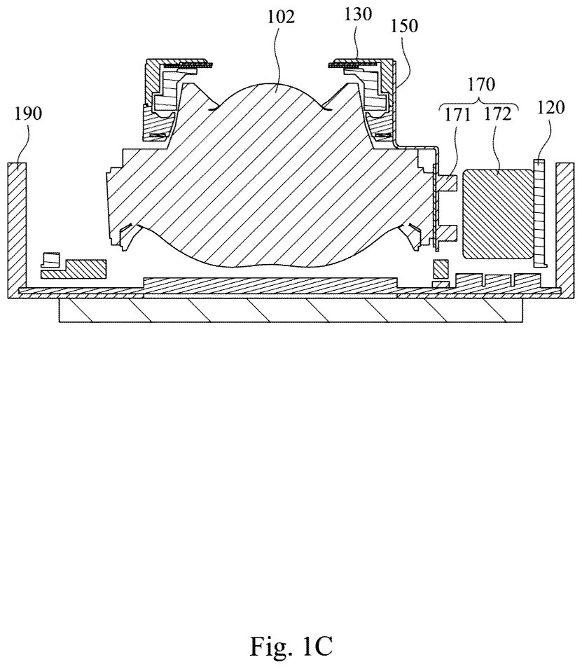

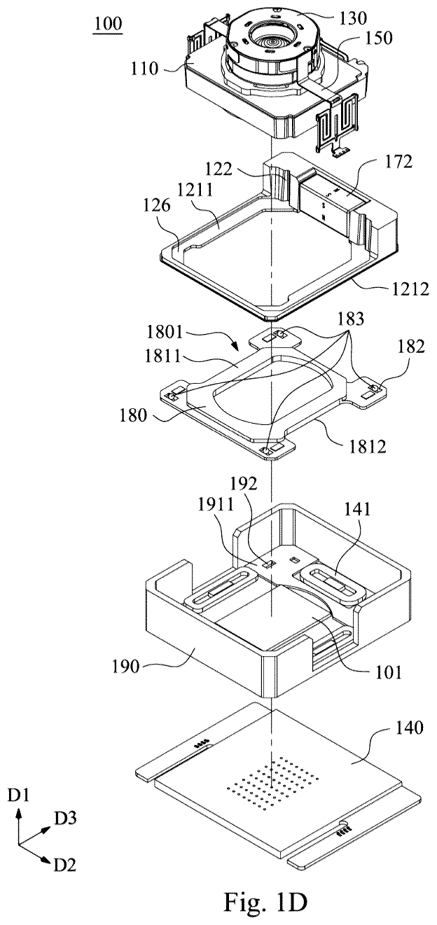

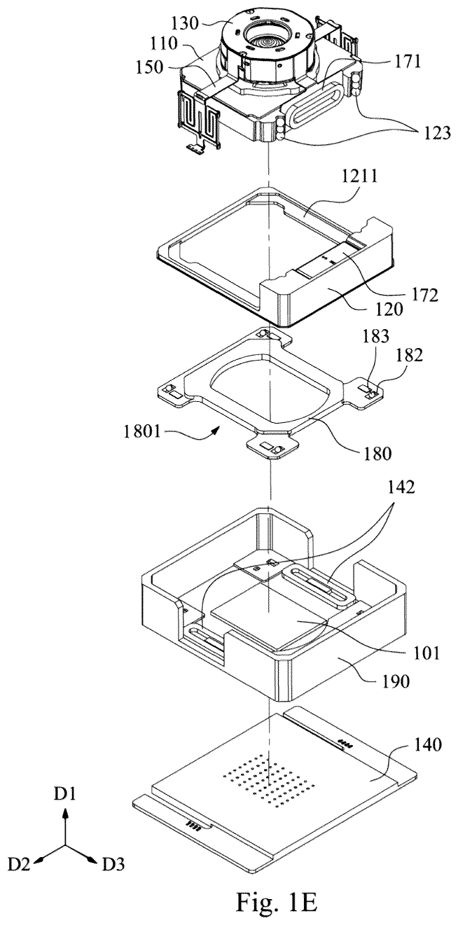

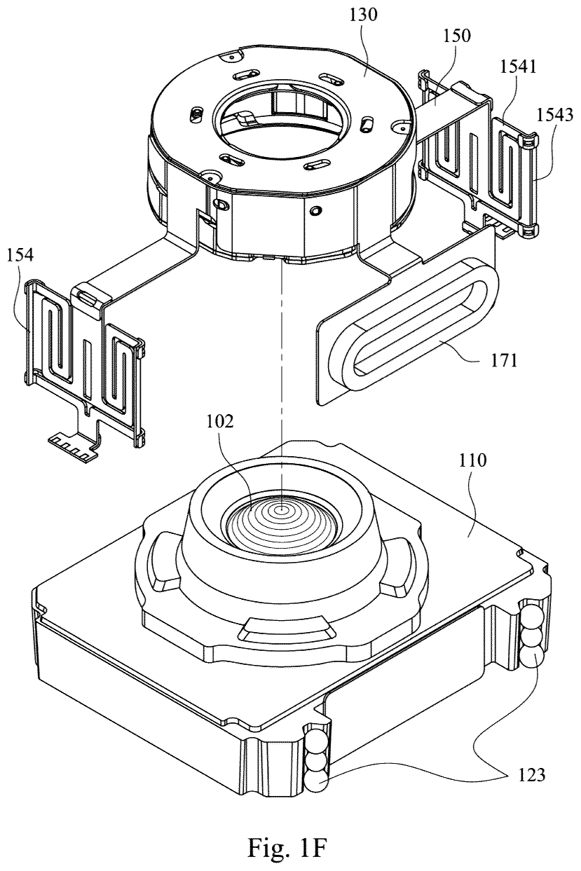

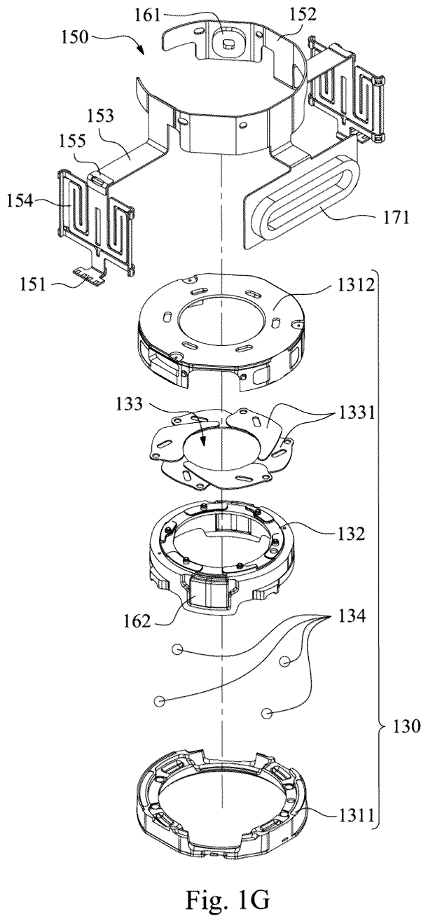

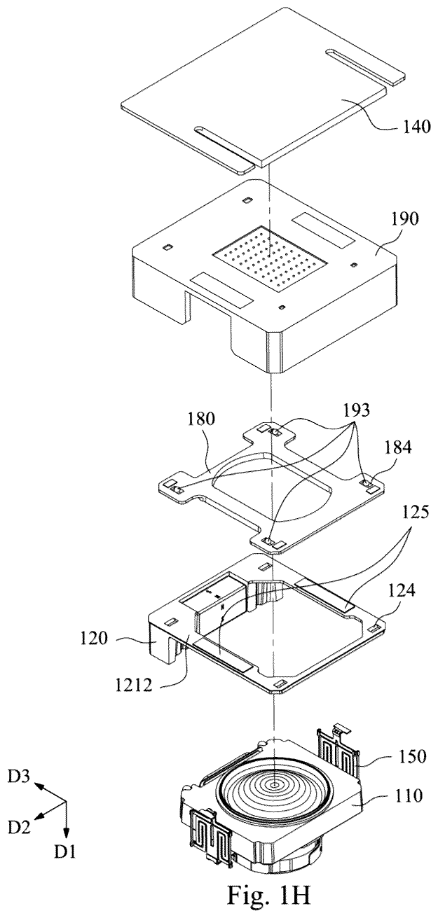

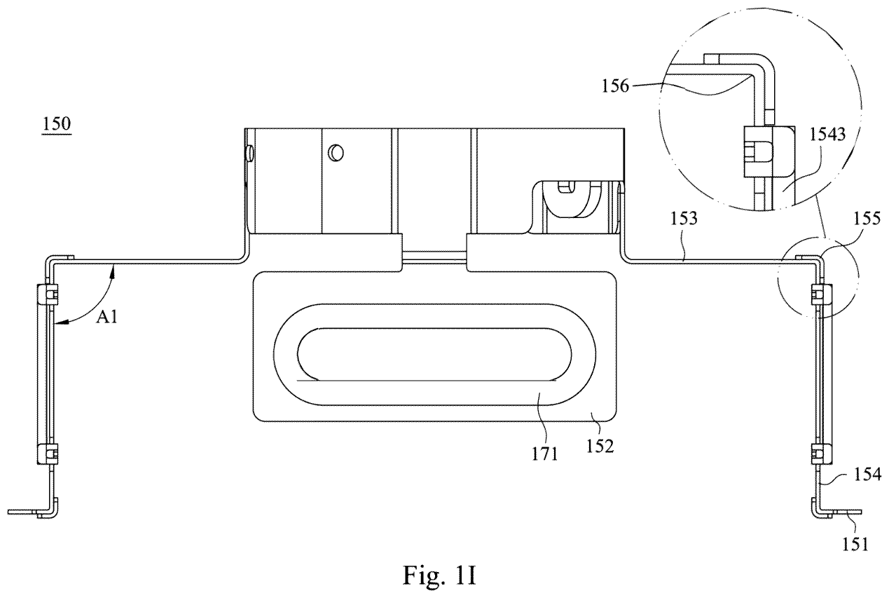

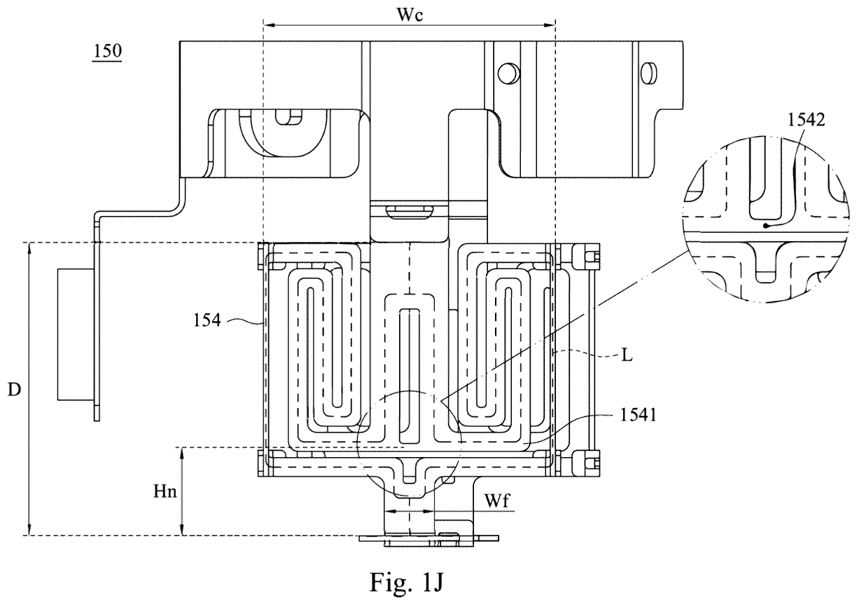

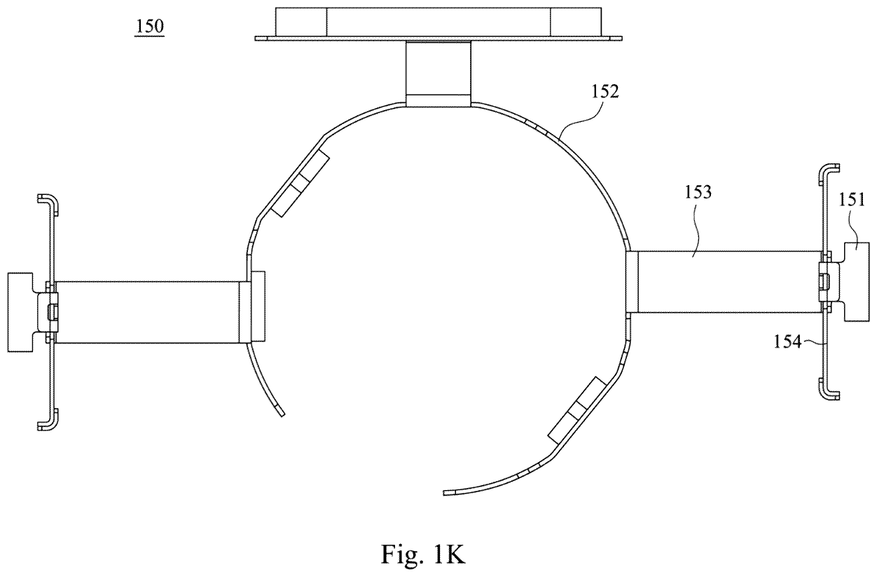

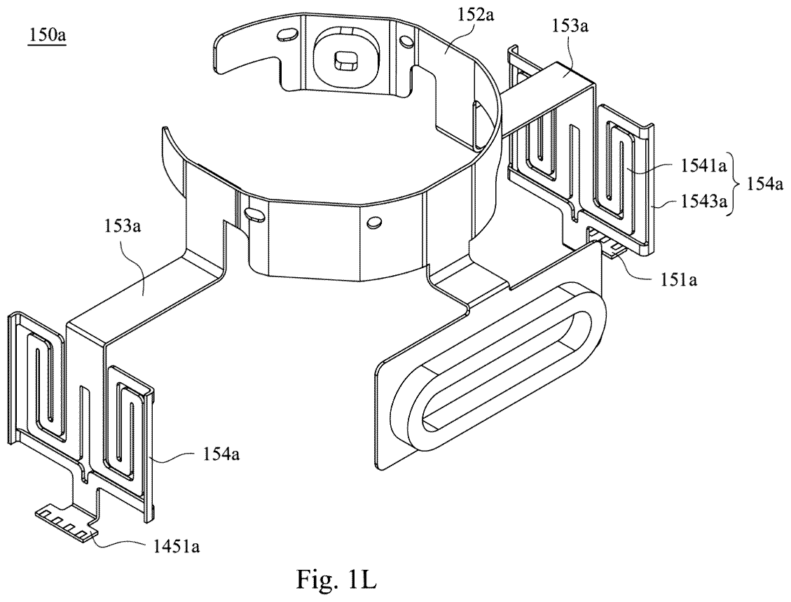

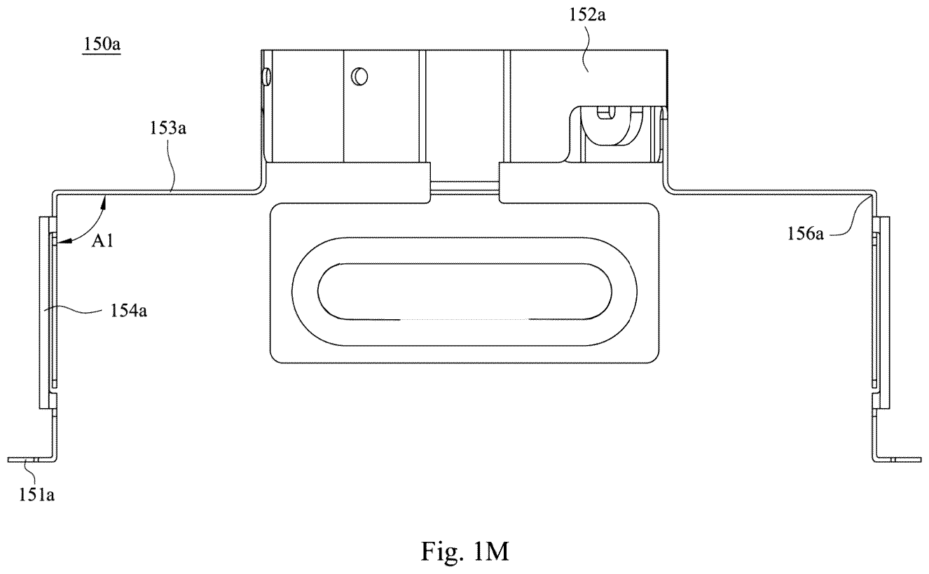

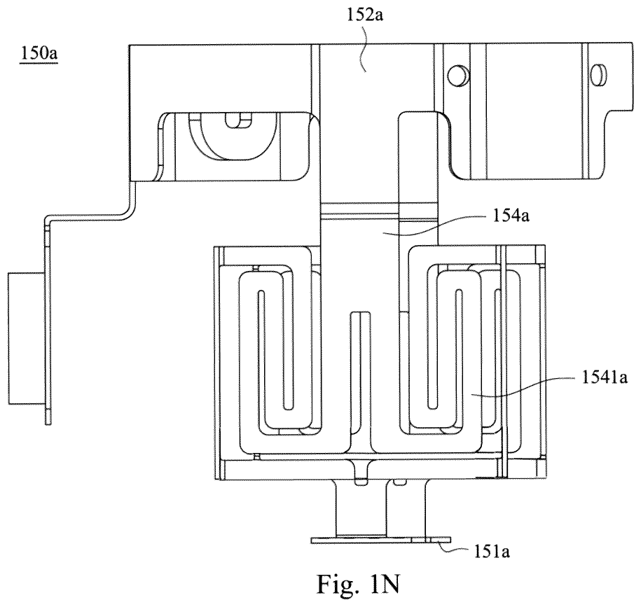

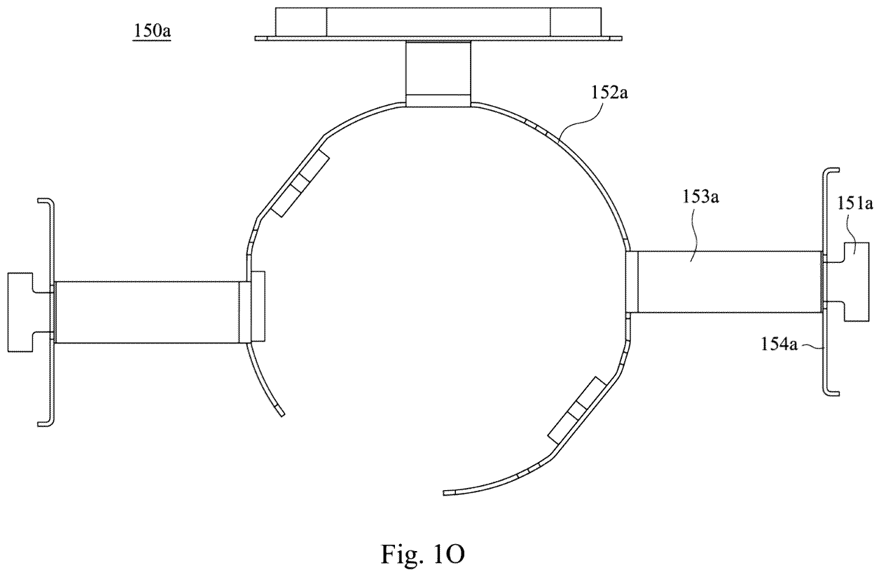

FIG. 1A is a schematic view of a camera module 100 according to one example of the 1st embodiment of the present disclosure. FIG. 1B is a plan view of the camera module 100 of FIG. 1A. In FIG. 1A and FIG. 1B, the camera module 100 includes an imaging lens driving module (its reference numeral is omitted) and an image sensor 101 (labelled in FIG. 1D), wherein the image sensor 101 is relative to an image surface (its reference numeral is omitted) of the imaging lens assembly 102 in the imaging lens driving module.

FIG. 1C is a cross-sectional view along line 1C-1C of FIG. 1B. FIG. 1D is an exploded view of the camera module 100 of FIG. 1A. FIG. 1E is another exploded view of the camera module 100 of FIG. 1A. FIG. 1F is a three dimensional view of a lens carrier 110, a variable aperture element 130 and a flexible wire plate 150 of the camera module 100 of FIG. 1E. FIG. 1G is an exploded view of partial elements of the camera module 100 of FIG. 1F. FIG. 1H is another exploded view of the camera module 100 of FIG. 1A. In FIG. 1A to FIG. 1H, the imaging lens driving module includes the lens carrier 110, the imaging lens assembly 102, a first frame element 120, the variable aperture element 130, a circuit board 140, the flexible wire plate 150, a second frame element 180 and a third frame element 190. The imaging lens assembly 102 has an optical axis X, the imaging lens assembly 102 is disposed in the lens carrier 110. The circuit board 140 is disposed on an image side of the imaging lens assembly 102. The image sensor is disposed on the circuit board 140.

The first frame element 120 has a first surface 1211 and a second surface 1212. The second surface 1212 is relative to the first surface 1211. A first rail 122 is disposed on the first surface 1211 along a first direction D1. The first direction D1 is parallel to the optical axis X. The imaging lens assembly 102 is disposed on the first rail 122 via a first ball element 123. A second rail 124 is disposed on the second surface 1212 along a second direction D2.

The second frame element 180 has a third surface 1811 and a fourth surface 1812, which are relative to each other. The third surface 1811 is movably disposed relative to the second surface 1212, so that the second frame element 180 is movable along the second direction D2, the second direction D2 is perpendicular to the first direction D1. The third surface 1811 has a third rail 182 relative to the second rail 124, the third rail 182 extends along the second direction D2, the fourth surface 1812 has a fourth rail 184 extending along a third direction D3.

Specifically, a number of each of the second rail 124 and the third rail 182 are four, which are located on four corners of the second surface 1212 and the third surface 1811, respectively. The imaging lens driving module can further include a plurality of third ball elements 183, which are disposed between the second rail 124 and the third rail 182, respectively, thus the first frame element 120 and the second frame element 180 can be movable relative to each other along the second direction D2.

The third frame element 190 has a fifth surface 1911, which is movably disposed relative to the fourth surface 1812, thus the third frame element 190 can be movable along the third direction D3, wherein the third direction D3 is perpendicular to the first direction D1 and the second direction D2. A fifth rail 192 is disposed on the fifth surface 1911 along the third direction D3.

Specifically, a number of each of the fourth rail 184 and the fifth rail 192 are four, which are located on four corners of the fourth surface 1812 and the fifth surface 1911, respectively. The imaging lens driving module can further include a plurality of fourth ball elements 193, which are disposed between the fourth rail 184 and the fifth rail 192, respectively, thus the second frame element 180 and the third frame element 190 can be movable relative to each other along the third direction D3.

In FIG. 1G, the variable aperture element 130 includes a fixing portion (its reference numeral is omitted), a rotating portion 132 and an aperture hole 133. The fixing portion is formed by two fixing elements 1311, 1312, which are fixed on the lens carrier 110. The rotating portion 132 is rotatable relative to the fixing portion, and has a plurality of blades 1331. The fixing elements 1311, 1312 are connected to each other from two ends of the rotating portion 132 along the optical axis X. The aperture hole 133 is formed by the blades 1331, wherein a plurality of second ball elements 134 are disposed between the fixing portion and the rotating portion 132, the fixing portion and the rotating portion 132 are rotatable relative to each other via the at least two second ball elements 134 so as to move the blades 1331 for enlarging or shrinking the aperture hole 133.

FIG. 1I is a plan view of the flexible wire plate 150 of the camera module 100 of FIG. 1G. FIG. 1J is a schematic view of partial parameters of the camera module 100 of FIG. 1A. FIG. 1K is another plan view of the flexible wire plate 150 of FIG. 1G. The flexible wire plate 150 includes a fixing end 151, a movable end 152, a first flexible portion 153, a second flexible portion 154 and a restrained element 155. The fixing end 151 is coupled to the circuit board 140. The movable end 152 is coupled to the lens carrier 110. The first flexible portion 153 is connected to the movable end 152. The second flexible portion 154 is connected to the first flexible portion 153 and the fixing end 151, wherein the second flexible portion 154 is closer to the fixing end 151 than the first flexible portion 153 to the fixing end 151. The restrained element 155 is coupled with the first flexible portion 153 and the second flexible portion 154 so as to form an angle A1 between the first flexible portion 153 and the second flexible portion 154. Further, the flexible wire plate 150 can include a turning section 156. One end of the turning section 156 is connected to the first flexible portion 153, the other end of the turning section 156 is connected to the second flexible portion 154, and the angle A1 is formed between the first flexible portion 153 and the second flexible portion 154, that is, the first flexible portion 153 and the second flexible portion 154 is turned at the turning section 156 for forming the angle A1, and the restrained element 155 is disposed relative to the turning section 156. Moreover, the flexible wire plate 150 includes polyimide.

In FIG. 1G, the imaging lens driving module further includes a first driving element (its reference numeral is omitted), which is electrically connected with the flexible wire plate 150. The first driving element is for driving the rotating portion 132 to rotate relative to the fixing portion so as to rotate the blades 1331 for enlarging or shrinking the aperture hole 133. In detail, the first driving element includes a first coil 161 and a first magnet 162. The first coil 161 is disposed on the fixing portion, the first magnet 162 is disposed on the rotating portion 132. The first coil 161 is relative to the first magnet 162, the rotating portion 132 can be driven to move relatively to the fixing portion by the first coil 161 and the first magnet 162, so that the blades 1331 are driven for enlarging or shrinking the aperture hole 133.

Specifically, the movable end 152 of the flexible wire plate 150 is an opened structure. A number of the first flexible portion 153 is two, which are extended from the movable end 152 outward, relatively. A number of the second flexible portion 154 is two, which are extended from the first flexible portions 153, respectively. A number of the fixing end 151 is two, which are located on one end of each of the second flexible portions 154.

Each second flexible portion 154 includes two meandering branches 1541, a node 1542 and two side vertical portions 1543. The meandering branches 1541 extend away from the fixing ends 151, wherein the meandering branches 1541 are overlapped observed along a specific direction. The meandering branches 1541 are converged at the node 1542 on a way extending towards the fixing ends 151. Each side vertical portion 1543 is connected to each meandering branch 1541.

In FIG. 1C, the imaging lens driving module further includes a second driving element 170, which is electrically connected to the flexible wire plate 150. The second driving element 170 is for driving the lens carrier 110 to move along the first direction D1. The second driving element 170 includes a second magnet 172 and a second coil 171. The second magnet 172 is fixed on the first frame element 120. The second coil 171 is fixed on the movable end 152, wherein the second magnet 172 is relative to the second coil 171, the lens carrier 110 is driven by the second magnet 172 and the second coil 171 to move along the first direction D1.

It should be mentioned that in FIG. 1D, FIG. 1E and FIG. 1H, the circuit board 140 is disposed on the third frame element 190, which is farther to the second frame element 180 than the fifth surface 1911 to the second frame element 180. A third coil 141 and two fourth coils 142 are disposed on the circuit board 140 via the third frame element 190. The third coil 141 is relative to the second magnet 172 on the first frame element 120 (that is, the second magnet 172 of the second driving element 170). The fourth coils 142 are disposed relative to two third magnets 125 of the first frame element 120, respectively. Specifically, the second frame element 180 has two openings 1801 relative to the fourth coils 142, the fourth coils 142 are disposed relative to the third magnets 125, respectively.

In FIG. 1J, when a shortest length of the second flexible portion 154 along the optical axis X is D, a total length of the meandering branches 1541 is L, the second flexible portion 154 has a maximum width being Wc close to the first flexible portion 153, each of the meandering branches 1541 has a minimum width Wf close to the fixing end 151, and a shortest distance between the fixing end 151 and the node 1542 along the optical axis X is Hn, the parameter of the example of the 1st embodiment are listed in the following Table 1.

TABLE 1

| | | | |
|---|---|---|---|
| D (mm) | 5.588 | Hn (mm) | 1.69 |
| L (mm) | 48.224 | L/D | 8.63 |
| Wc (mm) | 5.58 | Wc/Wf | 5.81 |
| Wf (mm) | 0.96 | Hn/D | 0.302 |

FIG. 1L is a three dimensional view of a flexible wire plate 150a of a camera module (its reference numeral is omitted) according to another example of the 1st embodiment of the present disclosure. FIG. 1M is a plan view of the flexible wire plate 150a of FIG. 1L. FIG. 1N is another plan view of the flexible wire plate 150a of FIG. 1L. FIG. 1O is another plan view of the flexible wire plate 150a of FIG. 1L. The different from the flexible wire plate 150 of the example in FIG. 1I is, the flexible wire plate 150a of FIG. 1L to FIG. 1O does not include restrained element and node. Other structures and the relationships between the flexible wire plate 150a and the camera module are the same with or similar to the example of FIG. 1I, the complete figure of the flexible wire plate 150a disposed in the camera module will not be illustrated herein.

In detail, the flexible wire plate 150a includes a fixing end 151a, a movable end 152a, a first flexible portion 153a and a second flexible portion 154a. The fixing end 151a is coupled to the circuit board. The movable end 152a is coupled to the lens carrier. The first flexible portion 153a is connected to the movable end 152a. The second flexible portion 154a is connected to the first flexible portion 153a and the fixing end 151a, wherein the second flexible portion 154a is closer to the fixing end 151a than the first flexible portion 153a to the fixing end 151a. The flexible wire plate 150a further includes a turning section 156a. One end of the turning section 156a is connected to the first flexible portion, the other end of the turning section 156a is connected to the second flexible portion 154a, and an angle A1 is formed between the first flexible portion 153a and the second flexible portion 154a, that is, the first flexible portion 153a and the second flexible portion 154a is turned at the turning section 156a for forming the angle A1. Moreover, the flexible wire plate 150a includes polyimide.

Specifically, the movable end 152a of the flexible wire plate 150a is an opened structure. A number of the first flexible portion 153a is two, which are extended from the movable end 152a outward, relatively. A number of the second flexible portion 154a is two, which are extended from the first flexible portions 153a, respectively. A number of the fixing end 151a is two, which are located on one end of each of the second flexible portions 154a.

Each second flexible portion 154a includes two meandering branches 1541a and two side vertical portions 1543a. The meandering branches 1541a extend away from the fixing ends 151a, wherein the meandering branches 1541a are overlapped observed along a specific direction. Each side vertical portion 1543a is connected to each meandering branch 1541a.

### 2nd Embodiment

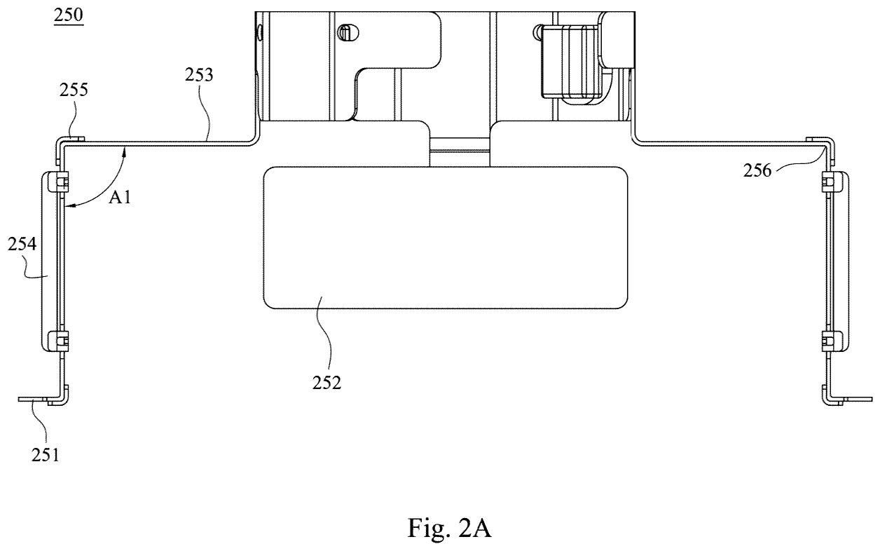

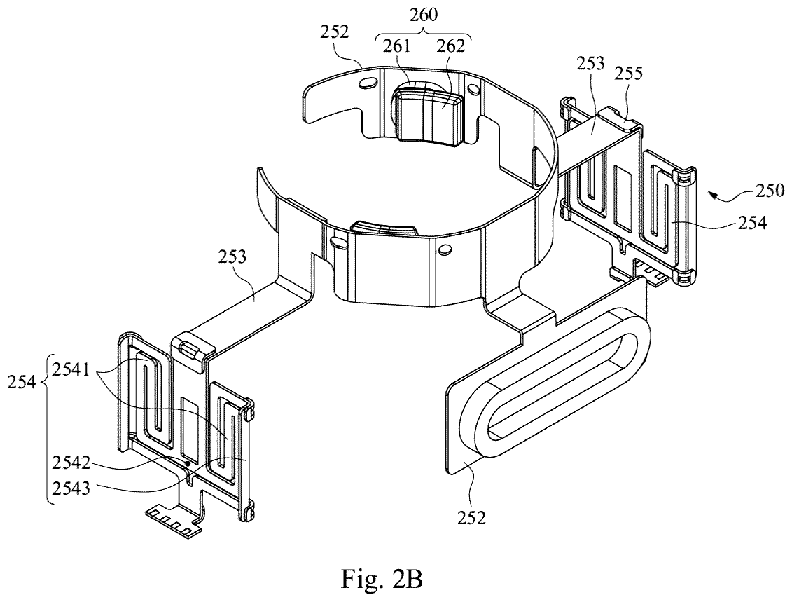

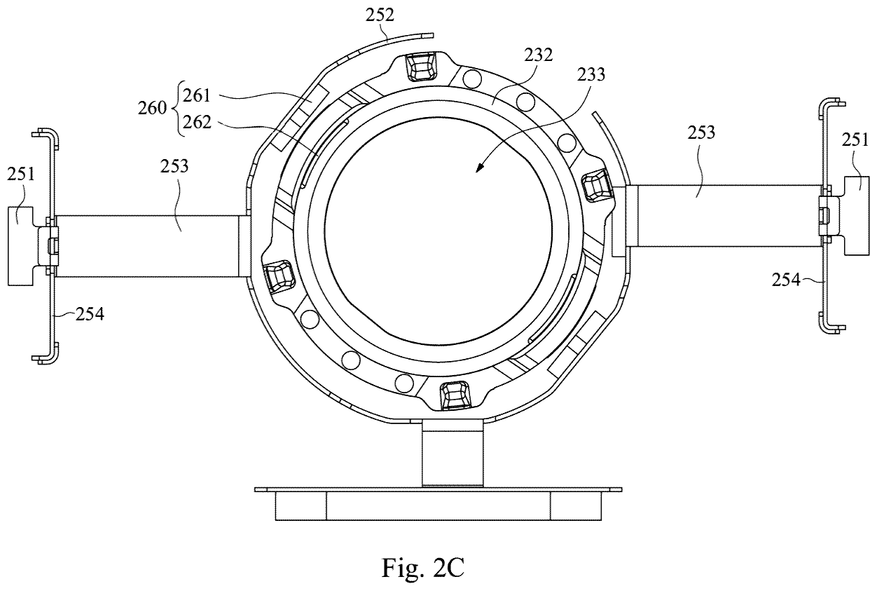

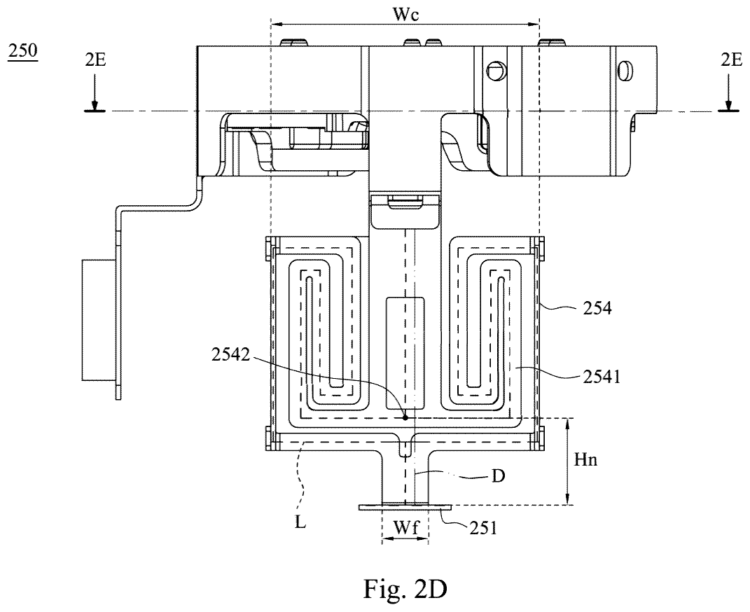

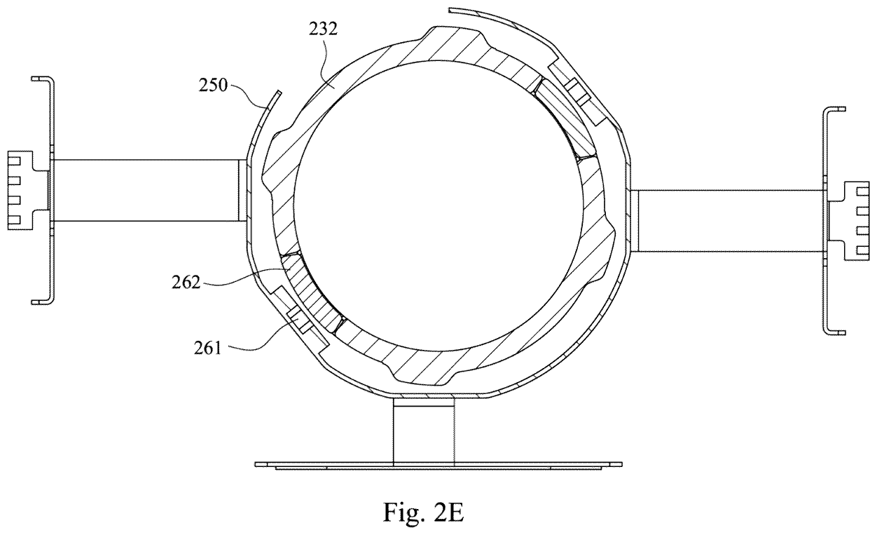

FIG. 2A is a plan view of a flexible wire plate 250 of a camera module (its reference numeral is omitted) according to one example of the 2nd embodiment of the present disclosure. FIG. 2B is a three dimensional view of the flexible wire plate 250 and a first driving element 260 of the camera module of FIG. 2A. FIG. 2C is a plan view of the first driving element 260 of FIG. 2B. FIG. 2D is another plan view of the flexible wire plate 250 of FIG. 2A. FIG. 2E is a cress-sectional view along line 2E-2E of FIG. 2D. According to the example of the 2nd embodiment of FIG. 2A to FIG. 2D, the camera module includes an imaging lens driving module (its reference numeral is omitted) and an image sensor (its reference numeral is omitted), wherein the image sensor is relative to an image surface (its reference numeral is omitted) of the imaging lens assembly (its reference numeral is omitted) in the imaging lens driving module. The imaging lens driving module includes the lens carrier (its reference numeral is omitted), the imaging lens assembly (its reference numeral is omitted), a first frame element (its reference numeral is omitted), the variable aperture element (its reference numeral is omitted), a circuit board (its reference numeral is omitted), the flexible wire plate 250, a second frame element (its reference numeral is omitted) and a third frame element (its reference numeral is omitted). It should be mentioned that the structure, arrangement and the connecting relationship of the aforementioned elements according to the example of the 2nd embodiment are the same with or similar to the corresponding elements according to each example of the 1st embodiment, and will not be described again herein.

The flexible wire plate 250 includes a fixing end 251, a movable end 252, a first flexible portion 253, a second flexible portion 254 and a restrained element 255. The fixing end 251 is coupled to the circuit board. The movable end 252 is coupled to the lens carrier. The first flexible portion 253 is connected to the movable end 252. The second flexible portion 254 is connected to the first flexible portion 253 and the fixing end 251, wherein the second flexible portion 254 is closer to the fixing end 251 than the first flexible portion 253 to the fixing end 251. The restrained element 255 is coupled with the first flexible portion 253 and the second flexible portion 254 so as to form an angle A1 between the first flexible portion 253 and the second flexible portion 254. Further, the flexible wire plate 250 can include a turning section 256. One end of the turning section 256 is connected to the first flexible portion 253, the other end of the turning section 256 is connected to the second flexible portion 254, and the angle A1 is formed between the first flexible portion 253 and the second flexible portion 254, that is, the first flexible portion 253 and the second flexible portion 254 is turned at the turning section 256 for forming the angle A1, and the restrained element 255 is disposed relative to the turning section 256. Moreover, the flexible wire plate 250 includes polyimide.

In FIG. 2B and FIG. 2C, the imaging lens driving module further includes a first driving element 260, which is electrically connected with the flexible wire plate 250. The first driving element 260 is for driving the rotating portion 232 to rotate relative to the fixing portion (its reference numeral is omitted) so as to rotate the blades (its reference numeral is omitted) for enlarging or shrinking the aperture hole 233. In detail, the first driving element 260 includes a first coil 261 and a first magnet 262. The first coil 261 is disposed on the fixing portion, the first magnet 262 is disposed on the rotating portion 232. The first coil 261 is relative to the first magnet 262, the rotating portion 232 can be driven to move relatively to the fixing portion by the first coil 261 and the first magnet 262, so that the blades are driven for enlarging or shrinking the aperture hole 233.

Specifically, the movable end 252 of the flexible wire plate 250 is an opened structure. A number of the first flexible portion 253 is two, which are extended from the movable end 252 outward, relatively. A number of the second flexible portion 254 is two, which are extended from the first flexible portions 253, respectively. A number of the fixing end 251 is two, which are located on one end of each of the second flexible portions 254.

Each second flexible portion 254 includes two meandering branches 2541, a node 2542 and two side vertical portions 2543. The meandering branches 2541 extend away from the fixing ends 251, wherein the meandering branches 2541 are overlapped observed along a specific direction. The meandering branches 2541 are converged at the node 2542 on a way extending towards the fixing ends 251. Each side vertical portion 2543 is connected to each meandering branch 2541.

In FIG. 2D, when a shortest length of the second flexible portion 254 along the optical axis X is D, a total length of the meandering branches 2541 is L, the second flexible portion 254 has a maximum width being Wc close to the first flexible portion 253, each of the meandering branches 2541 has a minimum width Wf close to the fixing end 251, and a shortest distance between the fixing end 251 and the node 2542 along the optical axis X is Hn, the parameter of the example of the 2nd embodiment are listed in the following Table 2.

TABLE 2

| | | | |
|---|---|---|---|
| D (mm) | 5.6731 | Hn (mm) | 0.81 |
| L (mm) | 26.0401 | L/D | 4.5901 |
| Wc (mm) | 5.58 | Wc/Wf | 5.8125 |
| Wf (mm) | 0.96 | Hn/D | 0.319 |

### 3rd Embodiment

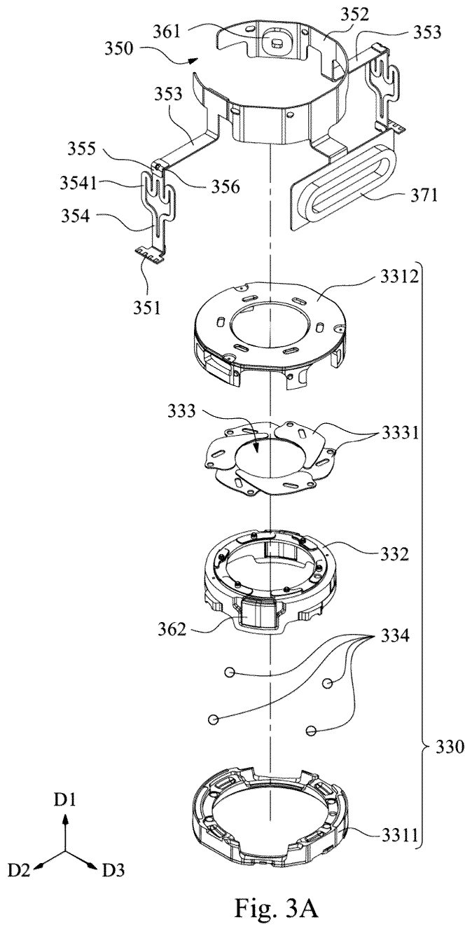

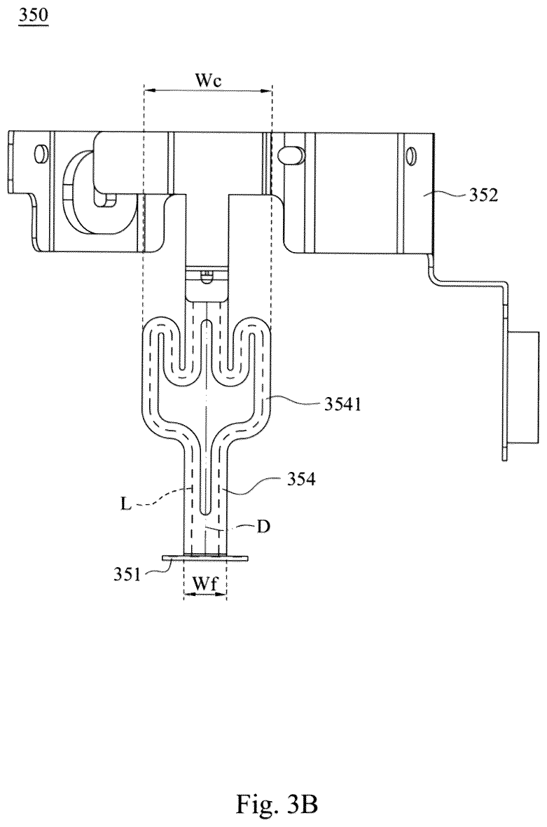

FIG. 3A is an exploded view of a variable aperture element 330 and a flexible wire plate 350 of a camera module (its reference numeral is omitted) according to one example of the 3rd embodiment of the present disclosure. FIG. 3B is a plan view of the flexible wire plate 350 of FIG. 3A. According to the example of the 3rd embodiment of FIG. 3A and FIG. 3B, the camera module includes an imaging lens driving module (its reference numeral is omitted) and an image sensor (its reference numeral is omitted), wherein the image sensor is relative to an image surface (its reference numeral is omitted) of the imaging lens assembly (its reference numeral is omitted) in the imaging lens driving module. The imaging lens driving module includes the lens carrier (its reference numeral is omitted), the imaging lens assembly (its reference numeral is omitted), a first frame element (its reference numeral is omitted), the variable aperture element 330, a circuit board (its reference numeral is omitted), the flexible wire plate 350, a second frame element (its reference numeral is omitted) and a third frame element (its reference numeral is omitted). It should be mentioned that the structure, arrangement and the connecting relationship of the aforementioned elements according to the example of the 3rd embodiment are the same with or similar to the corresponding elements according to each example of the 1st embodiment, and will not be described again herein.

The variable aperture element 330 includes a fixing portion (its reference numeral is omitted), a rotating portion 332 and an aperture hole 333. In FIG. 3A, the fixing portion is formed by two fixing elements 3311, 3312, which are fixed on the lens carrier. The rotating portion 332 is rotatable relative to the fixing portion, and has a plurality of blades 3331. The fixing elements 3311, 3312 are connected to each other from two ends of the rotating portion 332 along the optical axis X. The aperture hole 333 is formed by the blades 3331, wherein a plurality of second ball elements 334 are disposed between the fixing portion and the rotating portion 332, the fixing portion and the rotating portion 332 are rotatable relative to each other via the at least two second ball elements 334 so as to move the blades 3331 for enlarging or shrinking the aperture hole 333.

The flexible wire plate 350 includes a fixing end 351, a movable end 352, a first flexible portion 353, a second flexible portion 354 and a restrained element 355. The fixing end 351 is coupled to the circuit board. The movable end 352 is coupled to the lens carrier 310. The first flexible portion 353 is connected to the movable end 352. The second flexible portion 354 is connected to the first flexible portion 353 and the fixing end 351, wherein the second flexible portion 354 is closer to the fixing end 351 than the first flexible portion 353 to the fixing end 351. The restrained element 355 is coupled with the first flexible portion 353 and the second flexible portion 354 so as to form an angle (its reference numeral is omitted) between the first flexible portion 353 and the second flexible portion 354. Further, the flexible wire plate 350 can include a turning section 356. One end of the turning section 356 is connected to the first flexible portion 353, the other end of the turning section 356 is connected to the second flexible portion 354, and the angle is formed between the first flexible portion 353 and the second flexible portion 354, that is, the first flexible portion 353 and the second flexible portion 354 is turned at the turning section 356 for forming the angle, and the restrained element 355 is disposed relative to the turning section 356. Moreover, the flexible wire plate 350 includes polyimide.

The imaging lens driving module further includes a first driving element (its reference numeral is omitted), which is electrically connected with the flexible wire plate 350. The first driving element is for driving the rotating portion 332 to rotate relative to the fixing portion so as to rotate the blades 3331 for enlarging or shrinking the aperture hole 333. In detail, the first driving element includes a first coil 361 and a first magnet 362. The first coil 361 is disposed on the fixing portion, the first magnet 362 is disposed on the rotating portion 332. The first coil 361 is relative to the first magnet 362, the rotating portion 332 can be driven to move relatively to the fixing portion by the first coil 361 and the first magnet 362, so that the blades are driven for enlarging or shrinking the aperture hole 333.

Specifically, the movable end 352 of the flexible wire plate 350 is an opened structure. A number of the first flexible portion 353 is two, which are extended from the movable end 352 outward, relatively. A number of the second flexible portion 354 is two, which are extended from the first flexible portions 353, respectively. A number of the fixing end 351 is two, which are located on one end of each of the second flexible portions 354.

Each second flexible portion 354 includes two meandering branches 3541. The meandering branches 3541 extend away from the fixing ends 351, wherein the meandering branches 3541 are overlapped observed along a specific direction.

Further, the imaging lens driving module further includes a second driving element (its reference numeral is omitted), which is electrically connected to the flexible wire plate 350. The second driving element is for driving the lens carrier to move along the first direction D1. The second driving element includes a second magnet (its reference numeral is omitted) and a second coil 371. The second magnet is fixed on the first frame element. The second coil 371 is fixed on the movable end 352, wherein the second magnet is relative to the second coil 371, the lens carrier is driven by the second magnet and the second coil 371 to move along the first direction D1.

In FIG. 3B, when a shortest length of the second flexible portion 354 along the optical axis X is D, a total length of the meandering branches 3541 is L, the second flexible portion 354 has a maximum width being Wc close to the first flexible portion 353, and each of the meandering branches 3541 has a minimum width Wf close to the fixing end 351, the parameter of the example of the 3rd embodiment are listed in the following Table 3.

TABLE 3

| | | | |
|---|---|---|---|
| D (mm) | 5.6639 | Wf (mm) | 0.96 |
| L (mm) | 18.5974 | L/D | 3.2835 |
| Wc (mm) | 2.88 | Wc/Wf | 3.00 |

### 4th Embodiment

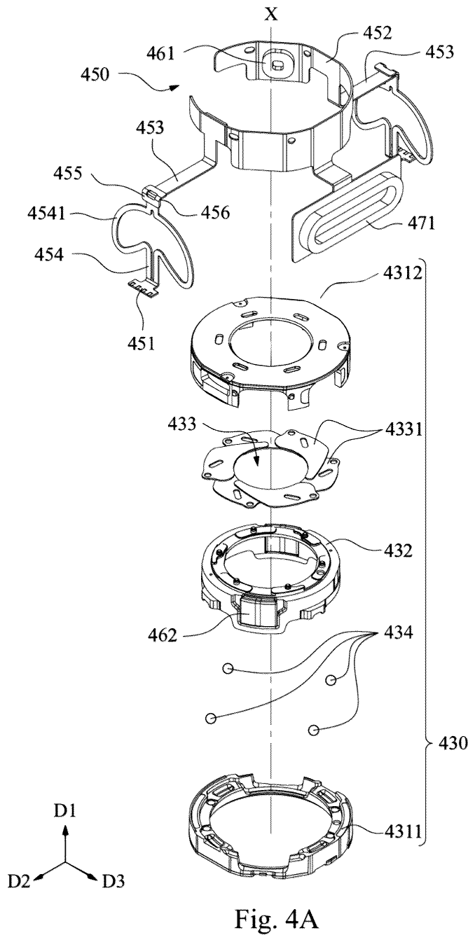

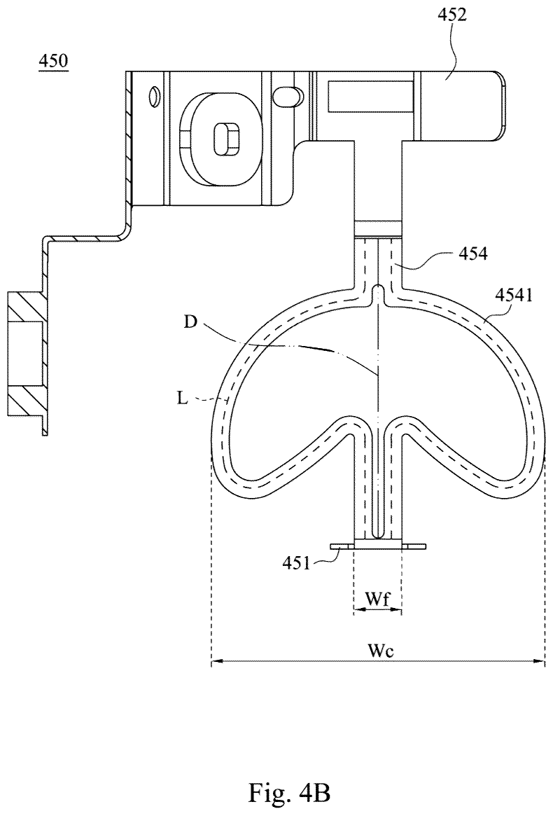

FIG. 4A is an exploded view of a variable aperture element 430 and a flexible wire plate 450 of a camera module (its reference numeral is omitted) according to one example of the 4th embodiment of the present disclosure. FIG. 4B is a plan view of the flexible wire plate 450 of FIG. 4A. According to the example of the 4th embodiment of FIG. 4A and FIG. 4B, the camera module includes an imaging lens driving module (its reference numeral is omitted) and an image sensor (its reference numeral is omitted), wherein the image sensor is relative to an image surface (its reference numeral is omitted) of the imaging lens assembly (its reference numeral is omitted) in the imaging lens driving module. The imaging lens driving module includes the lens carrier (its reference numeral is omitted), the imaging lens assembly (its reference numeral is omitted), a first frame element (its reference numeral is omitted), the variable aperture element 430, a circuit board (its reference numeral is omitted), the flexible wire plate 450, a second frame element (its reference numeral is omitted) and a third frame element (its reference numeral is omitted). It should be mentioned that the structure, arrangement and the connecting relationship of the aforementioned elements according to the example of the 4th embodiment are the same with or similar to the corresponding elements according to each example of the 1st embodiment, and will not be described again herein.

The variable aperture element 430 includes a fixing portion (its reference numeral is omitted), a rotating portion 432 and an aperture hole 433. In FIG. 4A, the fixing portion is formed by two fixing elements 4311, 4312, which are fixed on the lens carrier. The rotating portion 432 is rotatable relative to the fixing portion, and has a plurality of blades 4331. The fixing elements 4311, 4312 are connected to each other from two ends of the rotating portion 432 along the optical axis X. The aperture hole 433 is formed by the blades 4331, wherein a plurality of second ball elements 434 are disposed between the fixing portion and the rotating portion 432, the fixing portion and the rotating portion 432 are rotatable relative to each other via the at least two second ball elements 434 so as to move the blades 4331 for enlarging or shrinking the aperture hole 433.

The flexible wire plate 450 includes a fixing end 451, a movable end 452, a first flexible portion 453, a second flexible portion 454 and a restrained element 455. The fixing end 451 is coupled to the circuit board. The movable end 452 is coupled to the lens carrier. The first flexible portion 453 is connected to the movable end 452. The second flexible portion 454 is connected to the first flexible portion 453 and the fixing end 451, wherein the second flexible portion 454 is closer to the fixing end 451 than the first flexible portion 453 to the fixing end 451. The restrained element 455 is coupled with the first flexible portion 453 and the second flexible portion 454 so as to form an angle (its reference numeral is omitted) between the first flexible portion 453 and the second flexible portion 454. Further, the flexible wire plate 450 can include a turning section 456. One end of the turning section 456 is connected to the first flexible portion 453, the other end of the turning section 456 is connected to the second flexible portion 454, and the angle is formed between the first flexible portion 453 and the second flexible portion 454, that is, the first flexible portion 453 and the second flexible portion 454 is turned at the turning section 456 for forming the angle, and the restrained element 455 is disposed relative to the turning section 456. Moreover, the flexible wire plate 450 includes polyimide.

The imaging lens driving module further includes a first driving element (its reference numeral is omitted), which is electrically connected with the flexible wire plate 450. The first driving element is for driving the rotating portion 432 to rotate relative to the fixing portion so as to rotate the blades 4331 for enlarging or shrinking the aperture hole 433. In detail, the first driving element includes a first coil 461 and a first magnet 462. The first coil 461 is disposed on the fixing portion, the first magnet 462 is disposed on the rotating portion 432. The first coil 461 is relative to the first magnet 462, the rotating portion 432 can be driven to move relatively to the fixing portion by the first coil 461 and the first magnet 462, so that the blades are driven for enlarging or shrinking the aperture hole 433.

Specifically, the movable end 452 of the flexible wire plate 450 is an opened structure. A number of the first flexible portion 453 is two, which are extended from the movable end 452 outward, relatively. A number of the second flexible portion 454 is two, which are extended from the first flexible portions 453, respectively. A number of the fixing end 451 is two, which are located on one end of each of the second flexible portions 454.

Each second flexible portion 454 includes two meandering branches 4541. The meandering branches 4541 extend away from the fixing ends 451, wherein the meandering branches 4541 are overlapped observed along a specific direction.

Further, the imaging lens driving module further includes a second driving element (its reference numeral is omitted), which is electrically connected to the flexible wire plate 450. The second driving element is for driving the lens carrier to move along the first direction D1. The second driving element includes a second magnet (its reference numeral is omitted) and a second coil 471. The second magnet is fixed on the first frame element. The second coil 471 is fixed on the movable end 452, wherein the second magnet is relative to the second coil 471, the lens carrier is driven by the second magnet and the second coil 471 to move along the first direction D1.

In FIG. 4B, when a shortest length of the second flexible portion 454 along the optical axis X is D, a total length of the meandering branches 4541 is L, the second flexible portion 454 has a maximum width being Wc close to the first flexible portion 453, and each of the meandering branches 4541 has a minimum width Wf close to the fixing end 451, the parameter of the example of the 4th embodiment are listed in the following Table 4.

TABLE 4

| | | | |
|---|---|---|---|
| D (mm) | 6.0639 | Wf (mm) | 0.96 |
| L (mm) | 23.7584 | L/D | 3.918 |
| Wc (mm) | 6.7189 | Wc/Wf | 6.9988 |

### 5th Embodiment

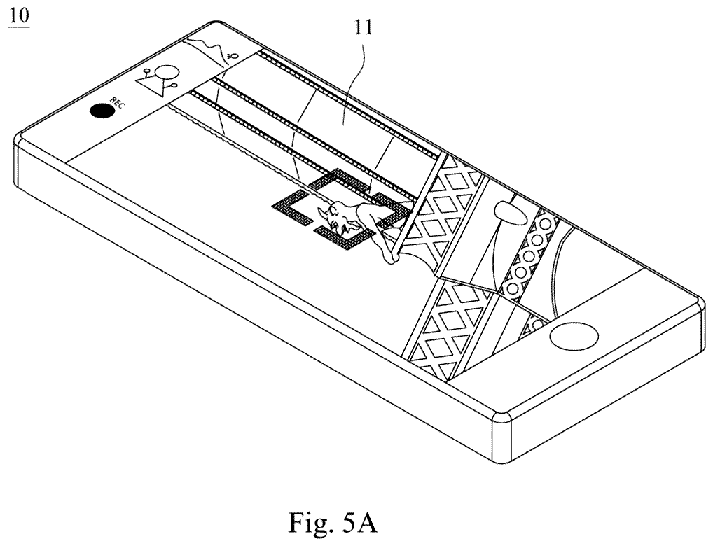

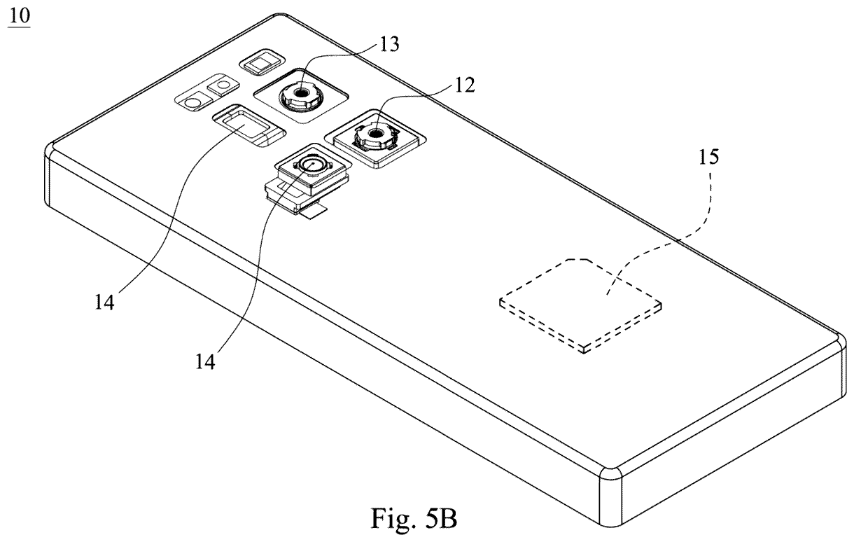

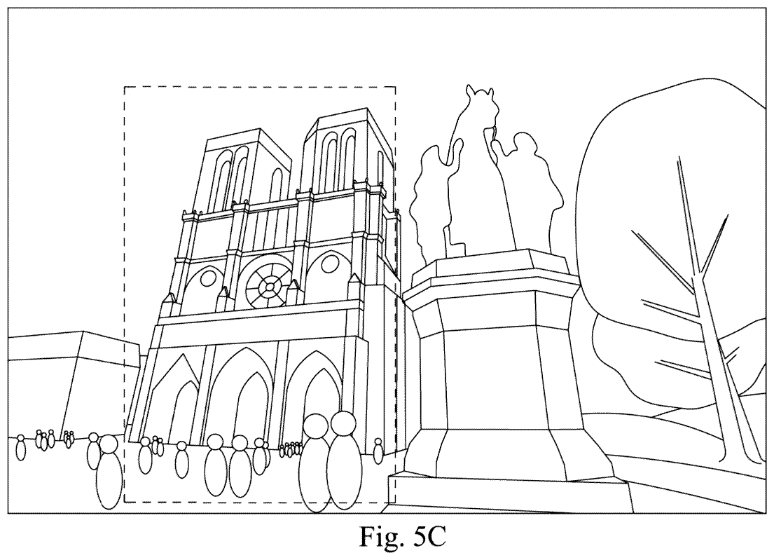

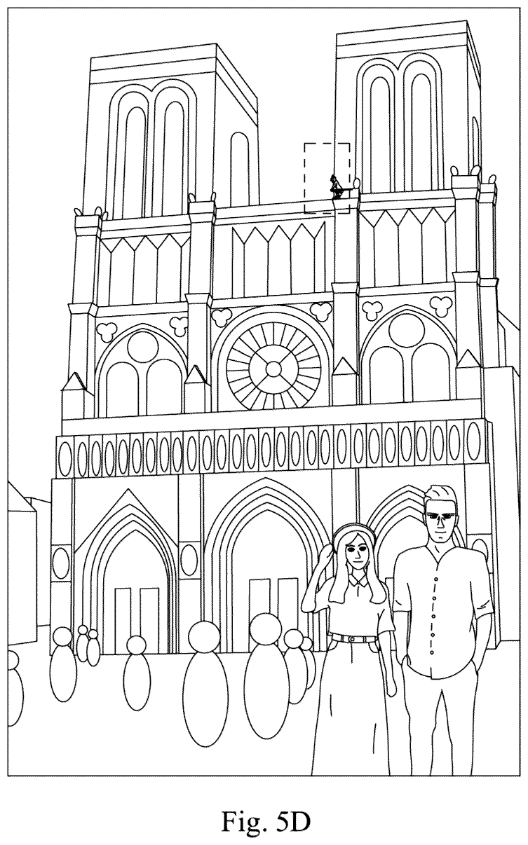

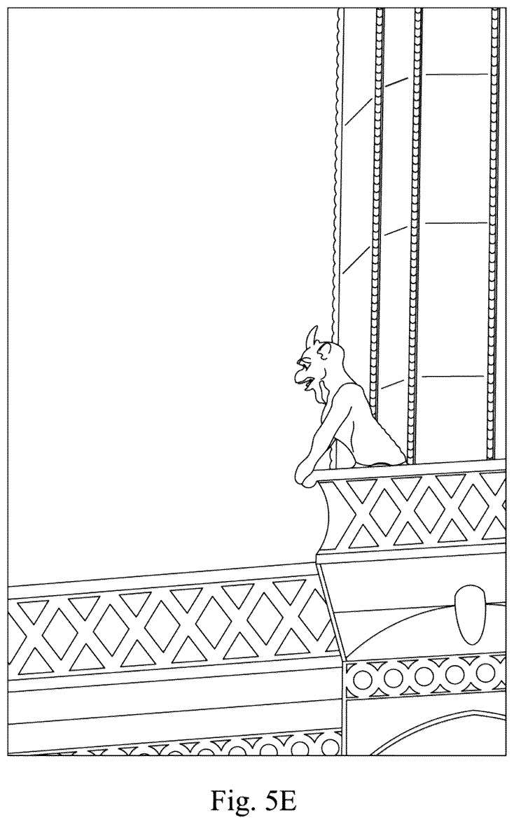

FIG. 5A is a schematic view of an electronic device 10 according to the 5th embodiment of the present disclosure. FIG. 5B is another schematic view of the electronic device 10 according to the 5th embodiment of FIG. 5A. As shown in FIG. 5A and FIG. 5B, the electronic device 10 is a smartphone. The electronic device 10 includes camera modules and a user interface 11. Further, the camera modules are an ultra-wide-angle camera module 12, a high-pixel camera module 13, and two telephoto camera modules 14, and the user interface 11 is a touch screen, but the present disclosure is not limited thereto. Specifically, each camera module can be any one of any example of the 1st embodiment to the 4th embodiment, and will not be limited thereto.

A user enters a shooting mode via the user interface 11. The user interface 11 is used to display the screen, and the shooting angle can be manually adjusted to switch between different camera modules. At this moment, the camera modules collect an imaging light on the respective image sensor (not shown in figures) and output electronic signals associated with images to an image signal processor (ISP) 15.

As shown in FIG. 5B, according to the camera specifications of the electronic device 10, the electronic device 10 can further include an optical anti-shake mechanism (not shown in figures). Further, the electronic device 10 can further include at least one focusing assisting module (not shown in figures) and at least one sensing component (not shown in figures). The focusing assisting module can be a flash module, an infrared distance measurement component, a laser focus module, etc. The flash module is for compensating the color temperature. The sensing component can have functions for sensing physical momentum and kinetic energies, such as an accelerator, a gyroscope, and a Hall effect element, so as to sense shaking or jitters applied by hands of the user or external environments. Thus the autofocus function and the optical anti-shake mechanism of the imaging lens assembly disposed on the electronic device 10 can function to obtain a great image quality and facilitate the electronic device 10 according to the present disclosure to have a capturing function with multiple modes, such as taking optimized selfies, high dynamic range (HDR) with a low light source, 4K resolution recording, etc. Furthermore, the user can visually see the captured image of the camera through the user interface 11 and manually operate the view finding range on the user interface 11 to achieve the auto focus function of what you see is what you get.

Furthermore, the camera modules, the optical anti-shake mechanism, the sensing component and the focusing assisting module can be disposed on a flexible printed circuit board (FPC) (not shown in figures) and electrically connected to the image signal processor 15 and so on via a connector (not shown in figures) so as to operate a picturing process. Recent electronic devices such as smartphones have a trend towards thinness and lightness.

The camera modules and the related elements are disposed on a FPC and circuits are assembled into a main board of an electronic device by a connector. Hence, it can fulfill a mechanical design of a limited inner space of the electronic device and a requirement of a circuit layout and obtain a larger allowance, and it is also favorable for autofocus functions of the camera modules obtaining a flexible control via a touch screen of the electronic device. In the 4th embodiment, the electronic device 10 can include a plurality of the sensing components and a plurality of the focusing assisting modules, and the sensing components and the focusing assisting modules are disposed on an FPC and another at least one FPC (not shown in figures) and electrically connected to the image signal processor 15 and so on via a corresponding connector so as to operate a picturing process. In other embodiments (not shown in figures), the sensing components and auxiliary optical elements can be disposed on a main board of an electronic device or a board of the other form according to a mechanical design and a requirement of a circuit layout.

Furthermore, the electronic device 10 can further include, but not be limited to, a display, a control unit, a storage unit, a random-access memory (RAM), a read-only memory (ROM), or the combination thereof.

FIG. 5C is a schematic view of an image captured via the electronic device 10 according to the 5th embodiment of FIG. 5A. As shown in FIG. 5C, a larger ranged image can be captured via the ultra-wide-angle camera module 12, which has a function for containing more views.

FIG. 5D is another schematic view of the image captured via the electronic device 10 according to the 5th embodiment of FIG. 5A. As shown in FIG. 5D, a certain ranged and high-pixel image can be captured via the high-pixel camera module 13, which has a function for high resolution and low distortion.

FIG. 5E is the other schematic view of the image captured via the electronic device 10 according to the 5th embodiment of FIG. 5A. As shown in FIG. 5E, a far image can be captured and enlarged to a high magnification via the telephoto camera modules 14, which has a function for a high magnification.

As shown in FIG. 5C to FIG. 5E, when an image is captured via different camera modules having various focal lengths and processed via a technology of an image processing, a zoom function of the electronic device 10 can be achieved.

### 6th Embodiment

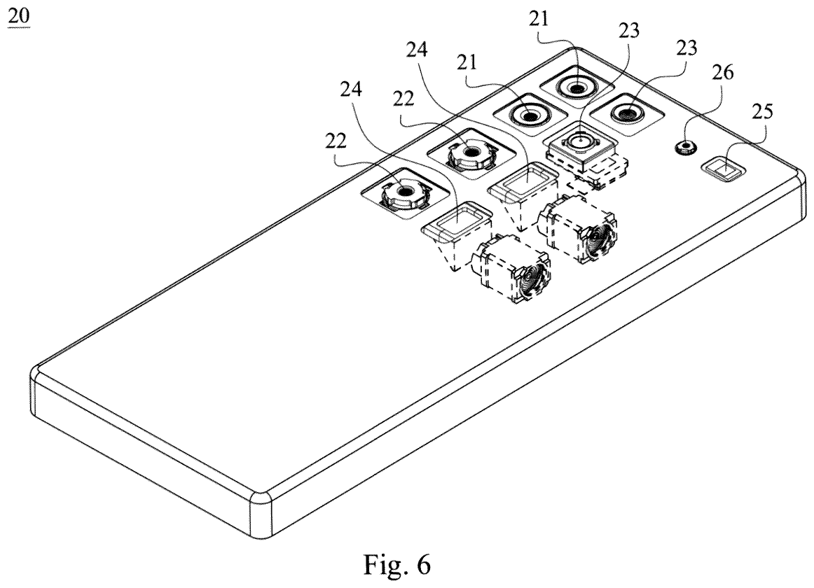

FIG. 6 is a schematic view of an electronic device 20 according to the 6th embodiment of the present disclosure. As shown in FIG. 6, the electronic device 20 is a smartphone. The electronic device 20 includes a plurality of camera modules. In detail, the camera modules are two ultra-wide-angle camera modules 21, two wide angle camera modules 22, four telephoto camera modules 23, 24, and a Time-Of-Flight (TOF) module 26, the TOF module 26 can be other types of camera module, which will not be limited to the present arrangement. Specifically, each camera module can be any one of any example of the 1st embodiment to the 4th embodiment, and will not be limited thereto.

Further, the camera modules 24 can have folding function of the light path, but the present disclosure will not be limited thereto.

According to the camera specifications of the electronic device 20, the electronic device 20 can further include an optical anti-shake mechanism (not shown in figures). Further, the electronic device 20 can further include at least one focusing assisting module (not shown in figures) and at least one sensing component (not shown in figures). The focusing assisting module can be a flash module 25, an infrared distance measurement component, a laser focus module, etc. The flash module 25 is for compensating the color temperature. The sensing component can have functions for sensing physical momentum and kinetic energies, such as an accelerator, a gyroscope, and a Hall effect element, so as to sense shaking or jitters applied by hands of the user or external environments. Thus, the autofocus function and the optical anti-shake mechanism of the camera modules disposed on the electronic device 20 can function to obtain a great image quality and facilitate the electronic device 20 according to the present disclosure to have a capturing function with multiple modes, such as taking optimized selfies, high dynamic range (HDR) with a low light source, 4K resolution recording, etc.

Furthermore, all of other structures and dispositions according to the 6th embodiment are the same as the structures and the dispositions according to the 5th embodiment, and will not be described again herein.

### 7th Embodiment

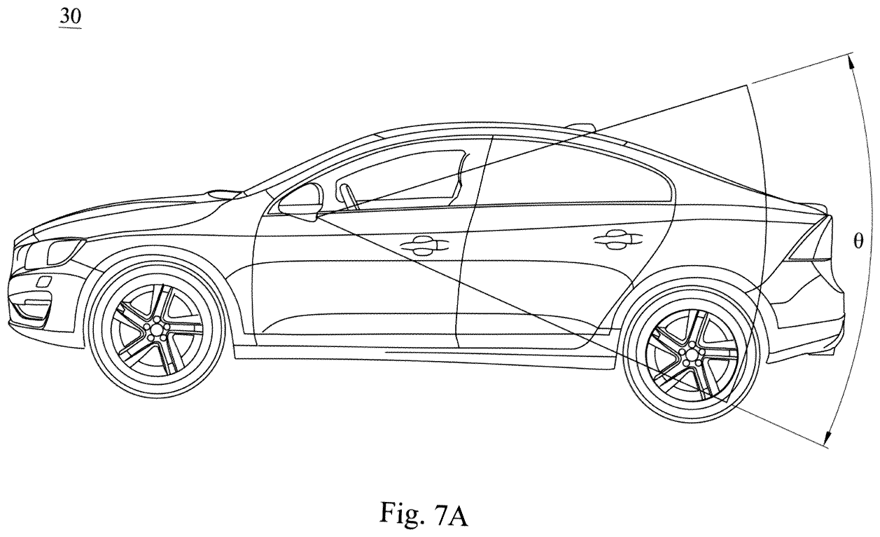

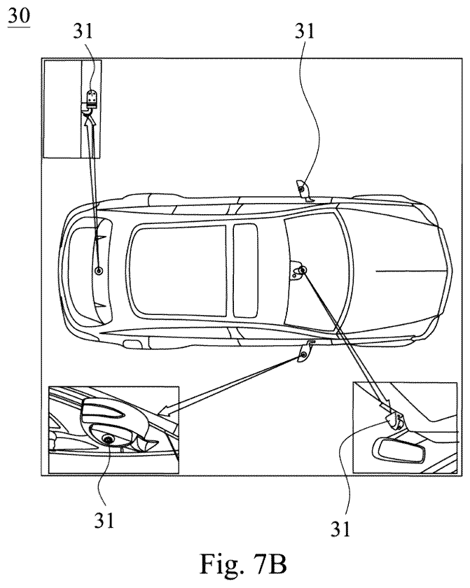

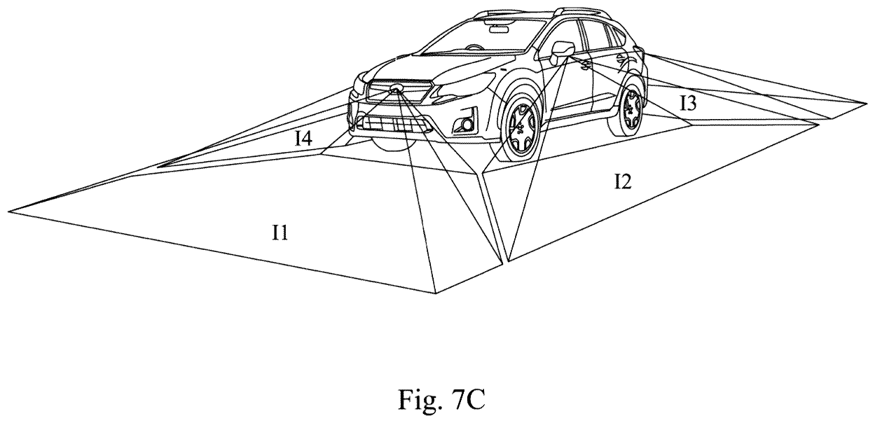

FIG. 7A is a schematic view of a vehicle instrument 30 according to the 7th embodiment of the present disclosure. FIG. 7B is another schematic view of the vehicle instrument 30 according to the 7th embodiment in FIG. 7A. FIG. 7C is another schematic view of the vehicle instrument 30 according to the 7th embodiment in FIG. 7A. In FIGS. 7A to 7C, an electronic device (its reference numeral is omitted) is applied to the vehicle instrument 30. The electronic device includes a plurality of camera modules 31. According to the 7th embodiment, a number of the camera modules 31 is six, and the camera modules 31 are vehicle camera modules. Specifically, each camera module can be any one of any example of the 1st embodiment to the 4th embodiment, and will not be limited thereto.

In FIGS. 7A to 7C, the camera modules 31 are automotive camera modules, two of the camera modules 31 are located under rearview mirrors on a left side and a right side, respectively, and the aforementioned camera modules 31 are configured to capture the image information of a visual angle θ. In particular, the visual angle θ can satisfy the following condition: 40 degrees<θ<90 degrees. Therefore, the image information in the regions of two lanes on the left side and the right side can be captured.

In FIGS. 7A to 7C, another two of the camera modules 31 can be disposed in the inner space of the vehicle instrument 30. It is favorable for the drivers obtaining the external space information in addition to the driving seat, such as the external space informations 11, 12, 13, 14, but the present disclosure is not limited thereto. Specifically, the aforementioned two camera modules 31 are disposed on a location close to the rearview mirror inside the vehicle instrument 30 and a location close to the rear car window, respectively. Moreover, the camera modules 31 can be further disposed on the rearview mirrors of the vehicle instrument 30 on the left side and the right side except the mirror surface, respectively, but the present disclosure is not limited thereto.

Another two of the camera modules 31 can be disposed on a front end of the vehicle instrument 30 and a rear end of the vehicle instrument 30, respectively. By disposing the camera modules 31 on the front end and the rear end of the vehicle instrument 30 and under the rearview mirror on the left side of the vehicle instrument 30 and the right side of the vehicle instrument 30, Therefore, more visual angles can be provided to reduce the blind spot, so that the driving safety can be improved. Further, the traffic information outside of the vehicle instrument 30 can be recognized by disposing the camera modules 31 on the periphery of the vehicle instrument 30, so that the function of the automatic driving assistance can be achieved.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

1. An imaging lens driving module, comprising:
a lens carrier;
an imaging lens assembly having an optical axis, and disposed in the lens carrier;
a first frame element having a first surface, wherein a first rail is disposed on the first surface along a first direction, the first direction is parallel to the optical axis, the imaging lens assembly is disposed on the first rail via a first ball element;
a variable aperture element comprising:
a fixing portion fixed on the lens carrier;
a rotating portion being rotatable relative to the fixing portion, and having at least two blades; and
an aperture hole formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole;
a circuit board disposed on an image side of the imaging lens assembly;
a flexible wire plate comprising:
a fixing end coupled and fixed to the circuit board;
a movable end coupled and fixed to the lens carrier;
a first flexible portion connected to the movable end;
a second flexible portion connected to the first flexible portion and the fixing end, wherein the second flexible portion is closer to the fixing end than the first flexible portion to the fixing end; and
a restrained element coupled with the first flexible portion and the second flexible portion so as to form an angle between the first flexible portion and the second flexible portion;
a first driving element for driving the rotating portion to rotate relative to the fixing portion so as to rotate the at least two blades for enlarging or shrinking the aperture hole; and
a second driving element for driving the lens carrier to move along the first direction;
wherein the first driving element and the second driving element are both electrically connected to the flexible wire plate;
wherein the second flexible portion of the flexible wire plate comprises:
at least two meandering branches extending away from the fixing end, wherein the at least two meandering branches are overlapped observed along a specific direction; and
a node, the at least two meandering branches converged at the node on a way extending towards the fixing end;
wherein a shortest length of the second flexible portion along a direction parallel to the optical axis is D, a total length of the meandering branches is L, and the following conditions are satisfied:
$$D < L ; and$$
$$1.4 < L / D < 17 .$$

2. The imaging lens driving module of claim 1, wherein the first frame element has a second surface relative to the first surface; the imaging lens driving module further comprises:
a second frame element having a third surface and a fourth surface, which are relative to each other, wherein the third surface is movably disposed relative to the second surface, thus the second frame element being movable along a second direction, the second direction is perpendicular to the first direction; and
a third frame element having a fifth surface, which is movably disposed relative to the fourth surface, thus the third frame element being movable along a third direction, wherein the third direction is perpendicular to the first direction and the second direction.

3. The imaging lens driving module of claim 2, wherein the second surface has a second rail extending along the second direction, the third surface has a third rail relative to the second rail, the third rail extends along the second direction, the fourth surface has a fourth rail extending along the third direction, the fifth surface has a fifth rail extending along the third direction; the imaging lens driving module further comprises:
a third ball element disposed between the second rail and the third rail, thus the first frame element and the second frame element being movable relative to each other along the second direction;
a fourth ball element disposed between the fourth rail and the fifth rail, thus the second frame element and the third frame element being movable relative to each other along the third direction;
wherein the circuit board comprises a third coil and at least two fourth coils, the third coil is disposed relative to a second magnet of the first frame element, and the at least two fourth coils are disposed relative to at least two third magnets of the first frame element, respectively.

4. The imaging lens driving module of claim 3, wherein the at least two third magnets are disposed on the second surface, the at least two fourth coils are disposed on the circuit board, the second frame element has at least two openings relative to the at least two fourth coils, the at least two fourth coils are disposed relative to at least two third magnets, respectively.

5. The imaging lens driving module of claim 4, wherein the third coil is disposed on the circuit board and relative to the second magnet.

6. The imaging lens driving module of claim 1, wherein the first driving element comprises:
a first coil disposed on the fixing portion; and
a first magnet disposed on the rotating portion, wherein the first coil is relative to the first magnet, the rotating portion can be driven to move relatively to the fixing portion by the first coil and the first magnet, thus the at least two blades are driven for enlarging or shrinking the aperture hole.

7. The imaging lens driving module of claim 1, wherein the second driving element comprises:
a second magnet fixed on the first frame element; and
a second coil fixed on the movable end, wherein the second magnet is relative to the second coil, the lens carrier is driven by the second magnet and the second coil to move along the first direction.

8. The imaging lens driving module of claim 7, wherein the second flexible portion has a maximum width being Wc close to the first flexible portion, each of the meandering branches has a minimum width Wf close to the fixing end, and the following conditions are satisfied:
$$Wf < Wc ; and$$
$$1.5 < Wc / Wf < 16 .$$

9. The imaging lens driving module of claim 1, wherein the second flexible portion further comprises a side vertical portion connected to at least one of the at least two meandering branches.

10. The imaging lens driving module of claim 1, wherein the flexible wire plate comprises polyimide.

11. A camera module, comprising:
the imaging lens driving module of claim 1; and
an image sensor relative to an image surface of the imaging lens assembly in the imaging lens driving module.

12. An electronic device, comprising:
the camera module of claim 11.

13. An imaging lens driving module, comprising:
a lens carrier;
an imaging lens assembly having an optical axis, and disposed in the lens carrier;
a first frame element having a first surface, wherein a first rail is disposed on the first surface along a first direction, the first direction is parallel to the optical axis, the imaging lens assembly is disposed on the first rail via a first ball element;
a variable aperture element comprising:
a fixing portion fixed on the lens carrier;
a rotating portion being rotatable relative to the fixing portion, and having at least two blades; and
an aperture hole formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole;
a circuit board disposed on an image side of the imaging lens assembly;
a flexible wire plate comprising:
a fixing end coupled and fixed to the circuit board;
a movable end coupled and fixed to the lens carrier;
a first flexible portion connected to the movable end; and
a second flexible portion connected to the first flexible portion and the fixing end, wherein the second flexible portion is closer to the fixing end than the first flexible portion to the fixing end;
a first driving element for driving the rotating portion to rotate relative to the fixing portion so as to rotate the at least two blades for enlarging or shrinking the aperture hole; and
a second driving element for driving the lens carrier to move along the first direction;
wherein the first driving element and the second driving element are both electrically connected to the flexible wire plate;
wherein the second flexible portion of the flexible wire plate comprising:
at least two meandering branches extending away from the fixing end, the at least two meandering branches are overlapped observed along a specific direction;
wherein the second flexible portion has a maximum width being Wc close to the first flexible portion, each of the meandering branches has a minimum width Wf close to the fixing end, and the following conditions are satisfied:
$$Wf < Wc ; and$$
$$1.5 < Wc / Wf < 16 .$$

14. The imaging lens driving module of claim 13, wherein the first frame element has a second surface relative to the first surface; the imaging lens driving module further comprises:
a second frame element having a third surface and a fourth surface, which are relative to each other, wherein the third surface is movably disposed relative to the second surface, thus the second frame element being movable along a second direction, the second direction is perpendicular to the first direction; and
a third frame element having a fifth surface, which is movably disposed relative to the fourth surface, thus the third frame element being movable along a third direction, wherein the third direction is perpendicular to the first direction and the second direction.

15. The imaging lens driving module of claim 14, wherein the second surface has a second rail extending along the second direction, the third surface has a third rail relative to the second rail, the third rail extends along the second direction, the fourth surface has a fourth rail extending along the third direction, the fifth surface has a fifth rail extending along the third direction; the imaging lens driving module further comprises:
a third ball element disposed between the second rail and the third rail, thus the first frame element and the second frame element being movable relative to each other along the second direction;
a fourth ball element disposed between the fourth rail and the fifth rail, thus the second frame element and the third frame element being movable relative to each other along the third direction;
wherein the circuit board comprises a third coil and at least two fourth coils, the third coil is disposed relative to a second magnet, and the at least two fourth coils are disposed relative to at least two third magnets, respectively.

16. The imaging lens driving module of claim 15, wherein the at least two third magnets are disposed on the second surface, the at least two fourth coils are disposed on the circuit board, the second frame element has at least two openings relative to the at least two fourth coils, the at least two fourth coils are disposed relative to at least two third magnets, respectively.

17. The imaging lens driving module of claim 16, wherein the third coil is disposed on the circuit board and relative to the second magnet.

18. The imaging lens driving module of claim 13, wherein the first driving element comprises:
a first coil disposed on the fixing portion; and
a first magnet disposed on the rotating portion, wherein the first coil is relative to the first magnet, the rotating portion can be driven to move relatively to the fixing portion by the first coil and the first magnet, thus the at least two blades are driven for enlarging or shrinking the aperture hole.

19. The imaging lens driving module of claim 13, wherein the second driving element comprises:
a second magnet fixed on the first frame element; and
a second coil fixed on the movable end, wherein the second magnet is relative to the second coil, the lens carrier is driven by the second magnet and the second coil to move along the first direction.

20. The imaging lens driving module of claim 19, wherein the second flexible portion has the maximum width being Wc close to the first flexible portion, each of the meandering branches has the minimum width Wf close to the fixing end, and the following condition is satisfied:
$$1. 9 < Wc / Wf < 12.7 .$$

21. The imaging lens driving module of claim 13, wherein the second flexible portion further comprises a side vertical portion connected to at least one of the at least two meandering branches.

22. The imaging lens driving module of claim 13, wherein the flexible wire plate comprises:
a restrained element coupled with the first flexible portion and the second flexible portion so as to form an angle between the first flexible portion and the second flexible portion.

23. The imaging lens driving module of claim 13, wherein the flexible wire plate comprises polyimide.

24. An imaging lens driving module, comprising:
a lens carrier;
an imaging lens assembly having an optical axis, and disposed in the lens carrier;
a first frame element having a first surface, wherein a first rail is disposed on the first surface along a first direction, the first direction is parallel to the optical axis, the imaging lens assembly is disposed on the first rail via a first ball element;
a variable aperture element comprising:
a fixing portion fixed on the lens carrier;
a rotating portion being rotatable relative to the fixing portion, and having at least two blades; and
an aperture hole formed by the at least two blades, wherein at least two second ball elements are disposed between the fixing portion and the rotating portion, the fixing portion and the rotating portion are rotatable relative to each other via the at least two second ball elements so as to move the at least two blades for enlarging or shrinking the aperture hole;
a circuit board disposed on an image side of the imaging lens assembly;
a flexible wire plate comprising:
a fixing end coupled and fixed to the circuit board;
a movable end coupled and fixed to the lens carrier;
a first flexible portion connected to the movable end;
a second flexible portion connected to the fixing end, wherein the second flexible portion is closer to the fixing end than the first flexible portion to the fixing end; and
a turning section, one end of the turning section connected to the first flexible portion, the other end of the turning section connected to the second flexible portion, and an angle formed between the first flexible portion and the second flexible portion;
a first driving element for driving the rotating portion to rotate relative to the fixing portion so as to rotate the at least two blades for enlarging or shrinking the aperture hole; and
a second driving element for driving the lens carrier to move along the first direction;
wherein the first driving element and the second driving element are both electrically connected to the flexible wire plate;
wherein the second flexible portion of the flexible wire plate comprising:
at least two meandering branches extending away from the fixing end, wherein the at least two meandering branches are overlapped observed along a specific direction; and
a node, the at least two meandering branches converged at the node on a way extending towards the fixing end;
wherein a shortest distance between the fixing end and the node along the optical axis is Hn, a shortest length of the second flexible portion along the optical axis is D, and the following conditions are satisfied:
$$Hn < D ; and$$
$$0.1 \leq Hn / D \leq 0.5 .$$

25. The imaging lens driving module of claim 24, wherein the shortest distance between the fixing end and the node along the optical axis is Hn, the shortest length of the second flexible portion along the optical axis is D, and the following condition is satisfied:
$$0. 2 \leq Hn / D \leq 0.5 .$$

26. The imaging lens driving module of claim 24, wherein the first frame element has a second surface relative to the first surface; the imaging lens driving module further comprises:
a second frame element having a third surface and a fourth surface, which are relative to each other, wherein the third surface is movably disposed relative to the second surface, thus the second frame element being movable along a second direction, the second direction is perpendicular to the first direction; and
a third frame element having a fifth surface, which is movably disposed relative to the fourth surface, thus the third frame element being movable along a third direction, wherein the third direction is perpendicular to the first direction and the second direction.

27. The imaging lens driving module of claim 26, wherein the second surface has a second rail extending along the second direction, the third surface has a third rail relative to the second rail, the third rail extends along the second direction, the fourth surface has a fourth rail extending along the third direction, the fifth surface has a fifth rail extending along the third direction; the imaging lens driving module further comprises:
a third ball element disposed between the second rail and the third rail, thus the first frame element and the second frame element being movable relative to each other along the second direction;
a fourth ball element disposed between the fourth rail and the fifth rail, thus the second frame element and the third frame element being movable relative to each other along the third direction;
wherein the circuit board comprises a third coil and at least two fourth coils, the third coil is disposed relative to a second magnet of the first frame element, and the at least two fourth coils are disposed relative to at least two third magnets of the first frame element, respectively.

28. The imaging lens driving module of claim 27, wherein the at least two third magnets are disposed on the second surface, the at least two fourth coils are disposed on the circuit board, the second frame element has at least two openings relative to the at least two fourth coils, the at least two fourth coils are disposed relative to at least two third magnets, respectively.

29. The imaging lens driving module of claim 28, wherein the third coil is disposed on the circuit board and relative to the second magnet.

30. The imaging lens driving module of claim 24, wherein the first driving element comprises:
a first coil disposed on the fixing portion; and
a first magnet disposed on the rotating portion, wherein the first coil is relative to the first magnet, the rotating portion can be driven to move relatively to the fixing portion by the first coil and the first magnet, thus the at least two blades are driven for enlarging or shrinking the aperture hole.

31. The imaging lens driving module of claim 24, wherein the second driving element comprises:
a second magnet fixed on the first frame element; and
a second coil fixed on the movable end, wherein the second magnet is relative to the second coil, the lens carrier is driven by the second magnet and the second coil to move along the first direction.

32. The imaging lens driving module of claim 31, wherein the second flexible portion has a maximum width being Wc close to the first flexible portion, each of the meandering branches has a minimum width Wf close to the fixing end, and the following conditions are satisfied:
$$Wf < Wc ; and$$
$$1.5 < Wc / Wf < 16 .$$

33. The imaging lens driving module of claim 24, wherein the second flexible portion further comprises a side vertical portion connected to at least one of the at least two meandering branches.

34. The imaging lens driving module of claim 24, wherein the flexible wire plate comprises polyimide.

35. The imaging lens driving module of claim 24, wherein the first flexible portion extends along a direction perpendicular to the optical axis, the second flexible portion extends the direction parallel to the optical axis.
